(19) United States
(12) Patent Application Publication
(10) Pub. No.: US 2003/0008608 A1
(43) Pub. Date: Jan. 9, 2003

(54) Apparatus and method for removing bones from a disassembled animal carcass

(76) Inventors: Barbara J. Scalia, Sioux City, IA (US); Keith R. Tingelhoff, Dakota Dunes, SD (US); Randall W. Rader, Parker, CO (US); Paul L. Grueber, Lexington, NE (US); Larry W. Fallin, Moraga, CA (US); William G. Leary, Upton, MA (US); James F. Dill, Foxboro, MA (US); Richard M. Wiesman, Wayland, MA (US); Edward M. Kolvek, West Newbury, MA (US); J. Bruce LeDoyt, Newton, MA (US); Roland Estey, Concord, MA (US); Timothy J. Mason, Uxbridge, MA (US); Andrew Courier, Mansfield, MA (US); Victor L. Dowdell, Sharon, MA (US); Donald E. Stover, Indialantic, FL (US); Richard Terrazzano, Salem, NH (US)

Correspondence Address: BLACKWELL SANDERS PEPER MARTIN LLP, 720 OLIVE STREET, SUITE 2400, ST. LOUIS, MO, 63101, US

(21) Appl. No.: 09/899,433

(22) Filed: Jul. 5, 2001

(51) Int. Cl. A22C 18/00

(52) U.S. Cl. 452/157

(57) ABSTRACT

An apparatus and method for removing bones from a sub-primal cut meat portion, and more particularly, an apparatus and method for removing bones from a chuck blade sub-primal cut meat portion where said apparatus includes a carousel-type conveyor system arrangement having at least one mounting station and at least one meat cutting station. The carousel-type conveyor has a mounting fixture that is adapted to hold and manipulate and orient the meat cut such that bone removal can be performed effectively. The carousel-type conveyor in one embodiment is a rotation table which transitions the mounting fixture with the sub-primal cut mounted thereon to a position adjacent a cutting station. Each cutting station includes at least one reciprocating chisel blade assembly that is utilized to sever the meat from the bone by repetitively plunging and retracting a chisel blade into and from the meat and bone interface with a reciprocating stabbing action thereby severing the meat from the bone. The maneuvering and cutting pattern of the chisel blade assembly is controlled by a controller which can be a PLC or a computer or any other appropriate computing device.

### BACKGROUND OF THE INVENTION

1. Field of Invention

This invention relates generally to the disassembly and processing of animal carcass primal and sub-primal meat portions and, more particularly, to the removal of bones from primal and sub-primal cuts of meat.

2. Background Art

During the disassembly and processing of an animal carcass such as a beef carcass in preparation for delivery of meat products to market, the head is typically removed and the carcass is cut in half lengthwise along the spinal canal. Disassembly of the animal carcass may differ dependent on the type of animal and the protein product being processed. However, in the case of the beef carcass, after cutting the carcass in half, the carcass is then typically divided into its primal meat cut portions such as the “chuck primal cut”. The chuck primal cut of meat is from the head end of the halved carcass and includes the neck, arm bone and shoulder and a portion of the fifth through first rib. A sub-primal cut is a large section of the primal cut. For example, the chuck blade sub-primal cut is a portion of the chuck primal cut. The chuck blade sub-primal cut meat portion includes the neck and shoulder portion and a few inches of the ribs.

The removal of bones from primal and sub-primal cuts of meat is a very difficult and manually intensive operation. Many primal and sub-primal cuts of meat have a large number of bones of various sizes, shapes and contours that form a complex skeletal structure of the meat cut. For example, the chuck blade has the rib bone skeletal structure and the neck bone skeletal structure. Removing of bones from a sub-primal meat cut is very difficult because of the complex skeletal structure. Also primal and sub-primal cuts of meat particularly from a beef carcass can weigh more than 75 pounds and can have varying sizes, shapes and contours that make it difficult to manually manipulate the meat portion. A large portion of the disassembly of the meat and removal of bones is performed by utilizing powered cutting tools or hand held knives. Also, some portions of a given primal or sub-primal cut of meat may have bones that have contours that vary considerably with respect to each other which requires the use of a hand held knife that has a flexible blade. Each type of animal carcass and the portion of the carcass being processed, whether it is beef, pork, poultry, mutton, fowl, or similar animal, pose its own unique challenge with regard to bone removal.

For example, the chuck blade is a sub-primal cut of meat and bone from the front of the beef carcass that presents a difficult and manually intensive operation for removing the bones because of the different types of bone structure and the varying contours of each bone. The chuck blade sub-primal cut can weigh up to 90 pounds and is approximately 24 inches by 18 inches by 8 inches. The final products produced from the chuck blade vary greatly but are predominately boneless. Typically, the meat of the chuck blade needs to be separated from the bones in one piece with minimal damage to the meat, especially the muscles that are to become the chuck roll. Requiring the meat to be separated from the bone structure in one piece also requires a cutting tool and process that is adapted to follow the varying contours of the bone structure without destroying the meat. During typical processing of a chuck blade, the person removing the bones must remove the back strap tendon (ligamentum nuchae), the atlas bone and the rope meat (longus colli). The mock tender (supraspinatus) can be left attached or can be detached from the rest of the muscles depending on the product being made.

The process of manually removing the bones from the chuck blade involves manually manipulating the sub primal cut into several orientations so that the bones of the meat portion can be readily accessed. The size and weight and shape of the sub-primal cut makes this manual process very difficult. The bones are typically removed from the chuck blade utilizing a very flexible hand held knife. The individual performing the bone removal process (simply referred to as “de-boning”) manipulates the knife in and around the many various contours of each vertebra. The large number of bones with the various contours makes this process both difficult and time consuming. The neck vertebrae can be the most difficult in the entire cutting process because each vertebra contains many varying contours. The multiple manipulations of the knife performed by the operator in order to follow the various contours of the bone can lead to wrist and arm strains to the arm and wrist utilized to manipulate the knife. In addition, the featherbones, channel, and knuckles of the rib bone and thoracic vertebrae skeletal structure all present their own challenges because of their varying shapes, sizes and contours. Navigating a knife in and around these various bone groups results in a wide range of motion and manipulation of the knife and requires a wide range of force to be applied to the knife to navigate through each of these areas which again makes fatigue and injuries to the wrist and arm very common.

Staffing the chuck blade de-boning position is also challenging because it is difficult to find an individual who is willing and able to withstand the strain imposed on the wrist and arm. The complexity of the bones and the amount of effort required to remove the bones makes the chuck blade de-boning position (“chuck de-boner”) one of the most difficult staffing challenges in a packing house. The training period is longer than the training period for any other position. Also, many of the people who start the training process for the position move to another position before becoming qualified as a chuck de-boner because of the high level of difficulty. It is the difficulty of the chuck blade de-boning process that is the motivation behind the present invention, however, the present invention can be utilized on various carcass types and portions.

The chuck blade sub primal cut of meat in question is commonly known as the blade, chuck blade or chuck and includes the atlas bone, and all six (6) neck bones (therefor, seven (7) total cervical vertebrae), the first five rib (thoracic) vertebrae with the featherbones (spinal processes) and the first few inches of the first five rib bones. The vertebrae are in fact only half bones as the carcass has been split into two pieces along the length of the spinal canal. This chuck blade piece also includes the muscles attached to the bones. The piece does not include the blade bone (scapula), the arm bone (humerus), the shank bones (ulna and radius), or the muscles on the outside of these bones (clod).

The various manipulations to be performed and the various forces that must be applied to remove the bones from the chuck blade is a difficult and straining task for any individual. It is apparent, that the bones need to be removed from the chuck blade in a completely new manner. Any viable solution must eliminate or significantly reduce the stress, strain and difficulty of the current manually intensive operation. The process must also separate the meat from the bones in such a manner that the meat is maintained in one whole piece with minimal damage to the meat and minimal meat left remaining on the bones. There are at least two major technical challenges for developing a completely new method of de-boning the chuck blade. The first challenge is developing a fixture or process that would facilitate the manipulation and orientation of the chuck blade when the de-boning process is performed, and the second challenge is development of a new process that can follow the contours of the bones with whatever cutting implement is utilized.

### BRIEF SUMMARY OF INVENTION

The invention is an automated apparatus and method for removing bones from primal and sub-primal cuts of meat where one embodiment of the invention is specifically adapted to remove the bones from the chuck blade portion of meat or other similar meat cuts. An objective of the invention is to provide a fixture that eliminates or significantly reduces the stress, strain and difficulty involved in maneuvering and manipulating a meat portion into various orientations during the de-boning process. Another objective of the invention is to follow the contours of the skeletal bone structure of the meat portion with the cutting implement such that the meat is maintained in one piece with minimal damage to the meat and minimal meat remnants left on the bone structure. Yet another objective of the invention is to eliminate any special staffing requirements for the de-boning process.

One embodiment of the invention for removal of bones from the chuck blade sub-primal cut comprises three major stages of the apparatus and/or method. The first stage is a mounting stage which includes an apparatus and method for fixing the meat portion to a mounting fixture that is adapted to orient and secure the meat portion such that the de-boning process can be readily performed. The second stage involves separating the rib bone structure (blade bone structure) from the chuck blade meat cut. The third stage involves separating the neck bone structure from the meat. The stages could vary depending on the type of animal and the bone structure of the portion of meat being processed.

One embodiment of the mounting stage comprises a mounting fixture assembly further comprising a mounting panel where the panel has an upper flat panel portion and a lower arched panel portion where the flat panel portion of the mounting panel has a hooking member extending therefrom for hanging the meat cut portion. The upper flat panel portion is designed to support the rib bone structure and the lower arched panel portion is adapted to support the neck bone structure. The mounting panel is adapted to rotate upward and downward to position the meat portion with the correct orientation to facilitate the cutting process. Please note that the shape and features of the mounting panel can be modified to accommodate different types of meat portions. Also, the mounting panel can be adapted with other ranges of motion other than rotation up and down, which again is dependent upon the type of meat portion.

The second stage of this embodiment of the present invention is a method and apparatus that is the first of two bone separation operations for separating the bone from the meat. This second stage or first bone separation operation utilizes the mounting fixturing provided by the first stage to position the meat in the desired orientation. Then the second stage utilizes one or more reciprocating chisel blades oriented and having a range of motion suitable to separate the meat from a portion of the bones. This chuck blade embodiment of the present invention utilizes one reciprocating chisel blade for the first bone separation operation.

For this embodiment which specifically addresses de-boning of the chuck blade, the meat portion is transitioned to a third stage or the second bone separation operation. The platform or mounting panel reorients the meat portion as necessary and the third stage also utilizes one or more reciprocating chisel blades. This chuck blade embodiment utilizes an array of five reciprocating chisel blades for the second bone separation operation. In alternative embodiments, the meat portion is then transitioned to subsequent stages having one or more reciprocating chisel blades that are oriented and having a range of motion suitable to separate any bone types still attached to the meat portion. Once the meat and the bones are sufficiently separated, the weight of the meat will result in the meat pulling away from the bones completely and falling into a bin.

The reciprocating chisel blade assembly having a reciprocating action of the chisel blade and having various ranges of motion and compliancy along various directions of compliance is adapted to adjust to the contours of the specific skeletal structure on which they are operating. The chisel blade mechanisms can also be adapted with compliance capability along various directions of compliance to avoid binding of the tool or chipping away at the bone structure. For example, the directions of compliance can be vertically rotational or laterally rotational.

One embodiment of the invention can implement a carousel style system and process where the mounting stage and the various cutting stages or stations are arranged in a carousel configuration. The carousel system can have a plurality of mounting fixtures having mounting panels and mounted on a carousel-like fixture (a rotation table or similar apparatus) where the mounting fixtures can be rotated around to the various cutting stations. Once the mounting fixture is positioned at a given cutting station, for example, a station for the first bone separation operation as described above, the meat portion is oriented as necessary to facilitate cutting at that station.

The system can be fully automated or semi-automated and is a programmable logic controller (PLC) controlled device or computer controlled device. The PLC controls the rotation table operation as well as the control of the mounting fixture for positioning and orientation of the meat. The PLC will also control the reciprocating chisel blade operation.

The mounting panel and hook mechanism meets the objective of providing a fixture that eliminates the difficulty in maneuvering and manipulating the meat portion. The reciprocating chisel blade assembly adapted with an appropriate range of motion and adapted with compliance meets the objective of removing the meat in one piece with minimal damage to the meat and without chipping the bone structure. The fully automated PLC controlled system is designed to reduce the special staffing needs for a chuck de-boner and eliminates the intensive manual use of a handheld flexible knife.

### BRIEF DESCRIPTION OF DRAWINGS

For a better understanding of the present invention, reference may be made to the accompanying drawings.

FIG. 1 is a side view of a Beef Skeletal chart.

FIG. 2 is a side view of a Chuck Blade Skeletal chart.

FIG. 2A is a view of the bone structure with meat removed.

FIG. 2B is a radial cross section of a rib bone and rib vertebra.

FIG. 2C is a radial cross section of a neck bone vertebra.

FIG. 3 is a top front right perspective view of the carousel layout of the chuck blade de-boning machine.

FIG. 4 is a front view of the rib de-boning station.

FIG. 5 is a side view of neck station and mounting station.

FIG. 6 is a top rear side perspective view of a mounting fixture.

FIG. 6A is a side view of a mounting fixture.

FIG. 6B is a rear view of a mounting fixture.

FIG. 7 is a perspective view of the rib de-boning assembly.

FIG. 8 is a perspective view of a rib de-boning chisel blade assembly.

FIG. 9 is a perspective view of a meat tensioner assembly.

FIG. 10 is a perspective view of a neck de-boning assembly.

FIG. 10A is side view of a neck de-boning assembly in the engaged position.

FIG. 10B is a side view of a neck de-boning assembly in the disengaged position.

FIG. 11 is a detailed side view of a neck de-boning station.

FIG. 12 is a perspective view of a neck de-boning chisel blade assembly.

FIG. 12A is a side view of a neck de-boning chisel blade assembly.

FIG. 13 is a system diagram.

FIG. 14 is a functional flow diagram of one embodiment of the de-boning system;

FIG. 15 is a perspective view of an individual rib de-boning chisel blade and

FIG. 16 is a perspective view of an individual neck de-boning chisel blade.

### DETAILED DESCRIPTION OF INVENTION

For the purpose of this application, the term “arcual” means, of, relating to or having characteristics of or geometry of an arc.

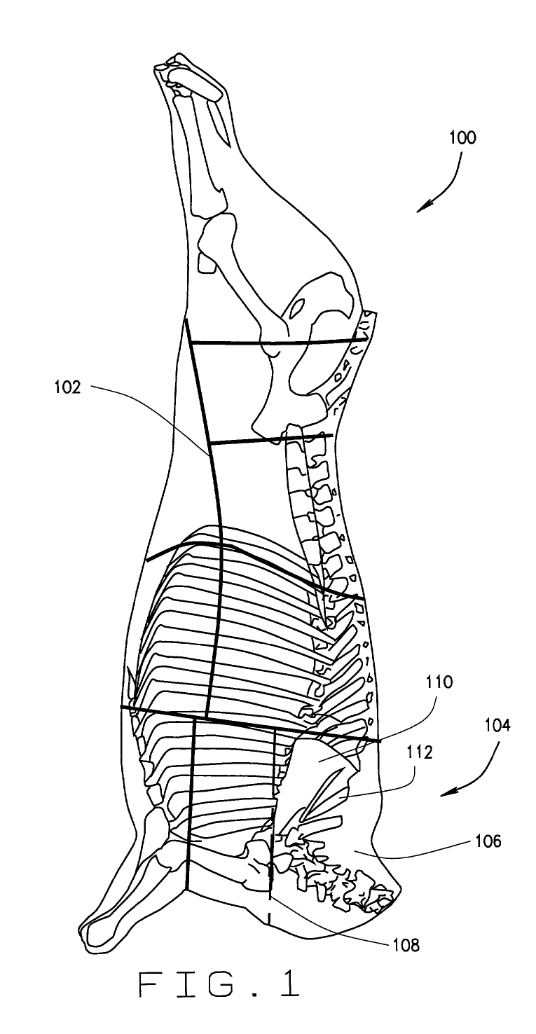

According to the embodiment(s) of the present invention, various views are illustrated in FIGS. 1-16 and like reference numerals are being used consistently to refer to like and corresponding parts of the invention for all of the various Figs. of the drawing. The first digit(s) of the reference number for a given item or part should correspond to the FIG. number in which the item or part is first identified.

The present invention comprising a plurality of mounting fixtures attached to a conveyor platform where the platform is adapted to position the mounting fixtures adjacent a station where mounting, removal or de-boning operations occur. One embodiment of the invention comprises a plurality of mounting fixtures attached to a conveyor platform where the platform is a rotation table and the mounting fixtures are attached in a carousel arrangement about the table, such that the mounting fixtures can be rotated or conveyed to a position adjacent a station. There is at least one mounting station and at least one bone removing station. The stations are positioned along the path of conveyance of the conveyor platform, a rotation table for this embodiment, and adjacent the conveyor.

At the bone removing stations, a de-boning assembly, including one or an array of reciprocating chisel blade assemblies affect the separation of meat and bone. This embodiment teaches a novel apparatus and method for separating bone from primal or sub-primal cuts of meat. The tip end of the chisel blade has a substantially unsharp edge, whereas the sides of the end portion (chisel head) of the blades are sharpened. The head or end of the chisel blade is extended to plunge with a stabbing action directed at the point where meat interfaces with bone. The stabbing action and retraction severs the meat from the bone at the point of contact primarily due to the sharpened sides. The reciprocating motion of the blade, extending and retracting, results in repetitive stabbing actions at the point where meat interfaces bone. During the reciprocating action, the blade is also traveling sideways (laterally) thereby affecting cuts with the sharpened sides. The autonomous chisel blade is automated to perform a cutting pattern or a set of cutting maneuvers affecting separation of meat from bone. The chisel blade and its cutting maneuvers can be designed or customized to accommodate a given primal or sub-primal cut of meat having a given skeletal bone structure. For a given cut of meat having multiple bone structures, each bone structure can be removed by a differently configured bone removing operation and chisel blade assembly. The chisel blade design can vary depending on the bone structure. The degrees of compliancy built into the chisel blade assembly may also vary. Also, different stages or stations could be set up where each stage has a differently configured chisel blade assembly. The conveyor platform or rotation table is adapted to position the mounting fixtures adjacent an operating de-boning station.

One embodiment of the present invention can be specifically designed for the removal of the bones from the chuck blade sub-primal cut of meat as this is one of the most difficult bone removal tasks in the meat packing house industry. As noted above, the chuck blade sub-primal cut of meat comprises an atlas bone and all six (6) neck bones (for a total of seven (7) cervical vertebrae), the first five rib (thoracic) vertebrae with the featherbones (spinal processes) and the first few inches of the first five rib bones. The vertebrae are in fact only half-bones as the carcass has been split into two pieces along the length of the spinal canal. This chuck blade also includes the muscles attached to the bones. The piece does not include the blade bone (scapula), the arm bone (humerus), the fore shank bones (ulna and radius), or the muscles on the outside of these bones (clod). Also, as noted above, the chuck blade can weigh up to ninety pounds and is approximately 24 inches by 18 inches by 8 inches. It is clear from the complexity of the bone structure and the size and weight of the meat that manually removing the meat in one whole piece is a difficult task particularly since it is required that the meat suffer minimal damage and that minimal meat is left on the bone structures.

The present invention further comprises other features such as various position sensors, compliant members, and meat mounting fixtures. This invention is also an automated method and apparatus for separating the meat from the bones. This method and apparatus will eliminate the stress and strain induced on the chuck de-boner who performs the task and will eliminate the special staffing requirements for the chuck de-boner position. More specifically, however, the present invention addresses two major problems. The first problem that the present invention addresses is the difficulty in holding, maneuvering and orienting the large sub-primal cut during the cutting operation. One embodiment of the invention specifically for the chuck blade utilizes a mounting fixture having a special hook and mounting panel for holding, maneuvering and positioning the meat. The second problem that this invention addresses is removing the meat while following the contours of the bones and while inducing minimal damage to the meat or bone and leaving minimal meat on the bones.

The present invention can be divided into two major functions based upon these two identified problems. The first function is the sub-primal cut handling function for mounting and holding, maneuvering and orienting the meat portion such that the bone and meat can be separated by a cutting tool. The second function is the actual separation of the bone from the meat while following the complex contours of the bone structure and while inducing minimal damage to the meat and leaving a minimal amount of meat residue on the bones. The second function can be a single function or can be further divided into two or more sub-functions where each sub-function is designed to remove a particular bone type or category of bones. In the case of the chuck blade, the method and apparatus includes two sub-functions. The first sub-function includes the removal of the rib bones from the chuck blade sub-primal cut. The second sub-function includes the removal of the neck bones from the chuck blade sub-primal cut of meat.

The division of the two sub-functions designed for the chuck blade is based on the two groups of similarly featured bone structures of the chuck blade sub-primal cut. The first similarly featured bone structure group referred to above as the rib bones include the five thoracic vertebrae that all have a feather bone and they all have a joint where the rib bone is connected to the vertebra and they all have a dip known as a channel between the feather bone and the rib knuckle. However, please note that the feather bones can optionally be separated from the meat prior to being operated on by the present embodiment of the invention designed for the chuck blade. The second group of bones is the seven cervical vertebrae (one atlas bone and six neck bones), all of which contain multiple processes that align in rows. These processes form ridges and valleys along the length of the cervical vertebrae. This bone group is referred to above as the neck bones. The invention removes the meat from these two groups of bones by approaching the two groups in different ways, hence the two sub-functions.

The first group of bones, which are the five thoracic vertebrae or rib bones, have variations in the arc of the ribs and the sides of the joint which make it difficult for one tool to adapt to the varying contours. However, this invention utilizes a single tool that comprises a reciprocating chisel blade that is utilized to separate the meat from the bones. This single reciprocating chisel blade assembly has various ranges of motion and compliancy in addition to the reciprocating action of the chisel blade. In general, however, the single reciprocating chisel blade removes the meat from the rib bone section starting at the fifth thoracic vertebra and continues the separation through the first thoracic vertebra. To accomplish this, the chisel blade sweeps back and forth side-to-side making iterative cutting actions and maneuvers around the meat portion in an arcual manner separating the meat from the bone with the reciprocating chisel blade that extends outwardly and retracts repeatedly thereby plunging into the meat with a stabbing action at the exposed point where the meat interfaces the bone thereby severing the meat from the bone primarily with the sharpened sides of the chisel blade. When the chisel blade assembly sweeps the full range in one direction, and meat separation is accomplished at that planar level, the chisel blade assembly steps down the thoracic vertebrae while the sweeping motion continues. As the meat is separated from the bone, the single chisel blade assembly continues to travel vertically downward along the thoracic vertebrae continuing to separate the meat from the bone with the stabbing, cutting action and the arcual side-to-side sweeping motion of the chisel blade. A single chisel blade can be used to separate meat from the rib bones because even though the rib bones have various contours, the overall structure of the bone is relatively consistent and uniform along the length of the bone. The rib bone structure also lends itself to being operated on by a single chisel blade because of its relatively flat anatomy. The reciprocating chisel blade assembly can be adapted such that the angle of extension of the chisel blade can be optimally adjusted.

Once the meat is separated from the rib bones, the meat is then separated from the neck bone portion of the chuck blade. The neck bone portion of the meat includes seven cervical vertebrae that form a complex skeletal structure having multiple contour variations that make it difficult to remove the bone from the meat utilizing an automated tool. To accomplish this task, one embodiment of this invention includes an array of five reciprocating chisel blade assemblies that are adapted to sweep around the meat portion while each of the reciprocating chisel blade assemblies extend and retract repeatedly and independently. The chisel blade assembly and control system are adapted such that the blades can be controlled to prevent simultaneous extensions of adjacent blades to prevent adjacent blades binding together. Also, the chisel blade assemblies are adapted to adjust position such that two or more chisel blade assemblies may be grouped closer together with respect to the remaining chisel blade assemblies. Also, the angle of extension of the chisel blade may be adjustable. This is also true for the single chisel blade assembly of the previous rib bone station. The chisel blade extends to penetrate the meat with a stabbing action and then retracts while traveling side-to-side and the cutting action thereby severing the meat from the bone, primarily with the sharpened sides of the chisel blade. Each individual chisel blade assembly within the array has built in compliancy to assist in removing meat from the various contours and to reduce the likelihood of the blade becoming bound. In addition to the reciprocating action, the chisel blade assemblies travel side-to-side in an arcual fashion about the mounting fixture. However, the array of five chisel blades do not travel vertically downward to remove the meat from the bone. Instead, the meat is rotated upward toward the plurality of reciprocating rotating chisel blades sequentially exposing the seventh through the first vertebra to meat interface which facilitates the separation of the meat from the bone until the meat is completely separated from the neck bone. At this point the skeletal bone structure that remains on the fixture can be removed for disposal or further processing. The array of chisel blade assemblies when optimally grouped with respect to each other and when adjusted to have an optimal angle of extension are effective for removing meat from a neck bone structure and other like bone structures having complex and inconsistent contours and crevices.

The mounting fixture for mounting, handling and holding the sub-primal cut utilized in this embodiment of the invention is important to the success of the invention. The sub-primal meat cut is hung against the mounting panel of the mounting fixture and the panel, having a flat upper portion and an arched lower portion, by a hook member extending from an upper portion of the flat portion of the panel and because of the weight of the meat cut, the piece of meat is usually hung with the fourth thoracic vertebra at the top but can also be hung on the fifth or third. As the meat is separated from the bone, the weight of the meat falling away from the bone pulls each bone of the vertebrae into a straight line. When removing the meat from the neck vertebrae, it is much easier to remove the meat from all of the crevices and contours if the vertebrae are arched outward and bent away from each other. This is the purpose of the arched portion of the mounting fixture panel where the arched portion rotates upward toward the cutting chisel blades such that the weight of the meat straightens the neck vertebrae and the vertebrae are bent away from each other along the arched portion. This fixturing concept in addition to the side-to-side arcual sweeping action of the multiple chisel blades is effective to remove the meat from the neck vertebrae. The conveyor platform or rotation table with mounting fixtures mounted thereon and the plurality of stations, some having one or more chisel blade assemblies, can be modified to accommodate other types of meat cuts while staying within the scope of the present invention. The process of examining the bone structure of a meat cut to identify the major bone structure categories and the similarities within a category, and then selecting the chisel blade assembly arrangement and the optimal cutting steps and maneuvers to be performed by the chisel blade, is an effective method in the de-boning process.

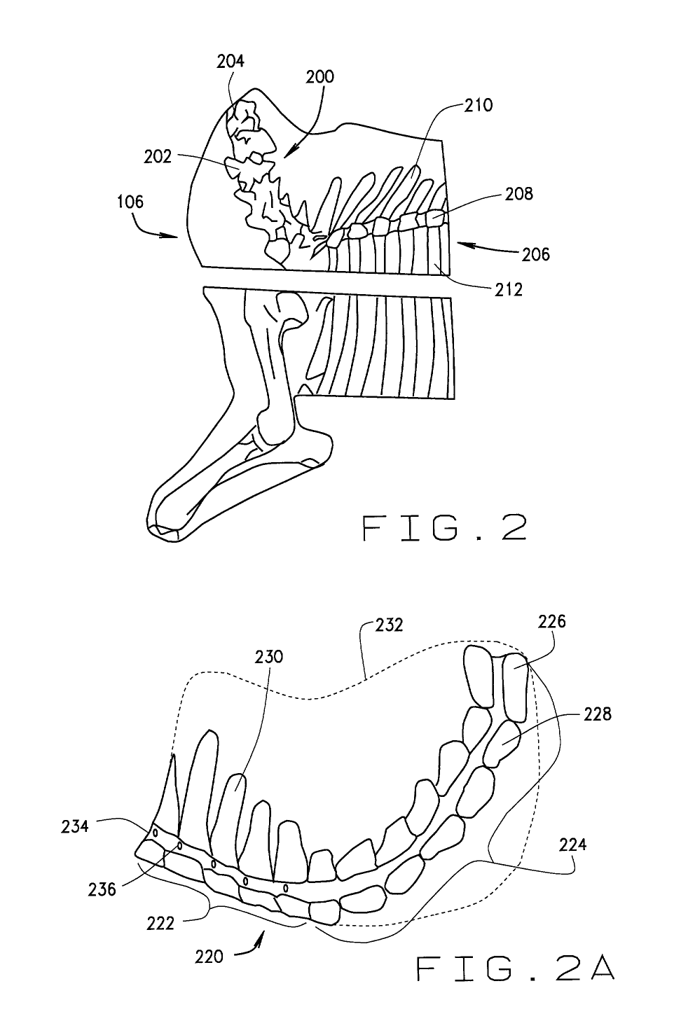

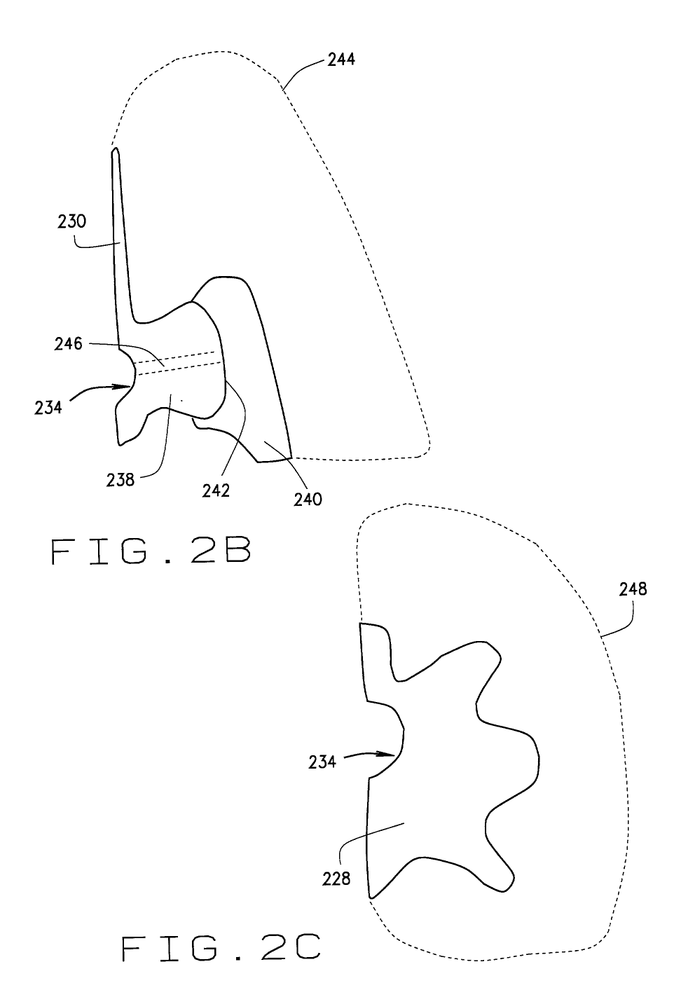

The details of the invention and specific embodiments can be better understood by referring to the figures of the drawing. Referring to FIG. 1, a side view of a beef carcass skeletal structure 100 is shown that reveals the primal meat cuts or primal meat cut portions of the beef carcass. A bold line 102 is shown that divides the beef carcass into the primal meat portions. When providing the detailed description of the various embodiments of the invention, the work item for which the discussion will focus is the chuck primal cut 104. More specifically, the work item for which the discussion will focus is the chuck blade sub-primal cut 106 which is the sub-primal cut above segmented dividing line 108. For the purpose of this discussion, it is assumed that the blade bone 110 (scapula) is already removed and that the five feather bones 112 can optionally be removed. Referring to FIG. 2, the chuck blade sub-primal cut 106 is shown. The skeletal bone structure of the chuck blade sub-primal cut can be divided into two major categories. The first category is the neck bone skeletal structure 200 which comprises the six neck bone cervical vertebrae 202 and the atlas bone cervical vertebra 204. The second skeletal structure category is the rib bone skeletal structure 206 (also referred to as blade bone skeletal structure) which comprises the first five rib (thoracic) vertebrae 208 with the feather bones (spinal processes) 210, and as much as the first few inches of the first five rib bones 212. It should be further noted that the vertebrae are in fact only half bone structures as the carcass during processing has been split in half along the length of the spinal canal. The sub-primal cut of meat also includes the attached muscles or meat including muscles that are commonly referred to as the chuck roll. The meat to be removed also includes the back strap tendon (ligamentum nuchae), the rope meat (longus colli) and the mock tender (supraspinatus).

It can be readily established upon examination of FIGS. 1 and 2 that there are complex skeletal structures within the chuck blade sub-primal cut and that each of the unique portions of the skeletal structure have different and distinct contours and protrusions which will make removal of meat from this sub-primal cut extremely difficult. However, to facilitate the handling of removal of the meat from the bone structure, the chuck blade sub-primal cut skeletal structure has been divided into two categories based on the two categories of the skeletal structure outlined above. It was decided to divide the sub-primal cut into these two major skeletal structures because the contours, although varying, are similar within each of the two categories. Therefore, the method and apparatus for separating the meat from the bone structure within a given skeletal structure category can be the same.

Referring to FIGS. 2A and 2B and 2C, the boneless structure of the chuck blade sub-primal meat cut is shown with the meat portions removed. However, the outline of the meat is reflected by a segmented line. Referring first to FIG. 2A, a side view of the spinal canal side of the chuck blade bone structure is shown. The chuck blade bone structure 220 has a naturally arched profile due to the tendons and muscle within the chuck blade sub-primal meat cut. This naturally arched profile of the bone structure adds to the difficulty of the de-boning process. This problem is mitigated, however, by hanging the meat vertically on a mounting panel such that the weight of the meat and gravity tends to straighten the alignment of bones. Also, as meat is removed and starts to drape over and hang downward, the bone structure alignment is further straightened, thereby further facilitating removal of meat from the neck bone structure.

The chuck blade sub-primal meat cut bone structure can be separated into two categories. The first category is the thoracic vertebrae 222 which is made up of five thoracic vertebra or rib vertebra. The second category is the cervical vertebrae 224, which comprises one atlas bone 226 and five cervical vertebrae 228 or neck vertebrae. There are also 5 feather bones 230 joined to the five rib vertebrae. The outline of the meat is reflected by segmented line 232. The spinal canal 234 is also shown which is defined by the series of connected vertebra as the spinal canal extends through each vertebra. There are five openings 236 in the wall of the spinal canal that opens to a channel that extends through each of the thoracic vertebra. This opening and channel allows nerves to extend from the spinal canal through the channel and out through to the various body components of the animal. This opening and channel are utilized to mount the chuck blade sub-primal meat cut on a mounting panel. This procedure will be described further below. The two categories of bone structures, the thoracic and the cervical, can be readily discerned upon examination of the bone structure anatomy. Once the categories have been determined, the cutting means or the de-boning means can be determined for a given category of bone structure.

Referring now to FIGS. 2B and 2C, radial cross sections of a thoracic vertebra and a cervical vertebra are shown respectively. FIG. 2B, which shows the radial cross section of a thoracic vertebra, further shows the feather bone 230, the spinal canal 234, a thoracic vertebra 238 and a rib bone 240. The joint between the thoracic vertebra 238 and the rib bone 240 is commonly referred to as the knuckle 242. The outline of the meat is shown by segmented line 244. The channel 246 that extends thorough the thoracic vertebra is the channel mentioned above which has opening 236. Again, channel 246 provides a pathway for nerves to extend from the spinal canal through the channel 246 and on to the various body parts of the animal. Also, when examining the thoracic vertebra and rib bone anatomy it is readily determined that the anatomy of the rib bone structure has a substantially flat anatomy. It is also noticed that the exterior contours of the bone structure are relatively uniform and consistent in all five vertebrae. Examining and determining these features of the bone structure for a given meat cut will facilitate the categorization of the various bone structures and further determining the de-boning means that will be utilized to optimally de-bone the meat cut.

Referring to FIG. 2C, a radial cross section of a neck vertebra 228 is shown. The spinal canal 234 is also shown. Also, the outline of the meat is shown by segmented line 248. It can be determined upon examining the neck vertebra that the contours of the bone anatomy are relatively nonuniform and inconsistent, particularly from one neck vertebra to the next. It also can be determined upon examination that the bone structure anatomy has a more rounded anatomy as opposed to a relatively flat anatomy. The determination of the contours of the anatomy of a bone structure assist in determining the de-boning means utilized to de-bone this portion of the chuck blade sub-primal meat cut.

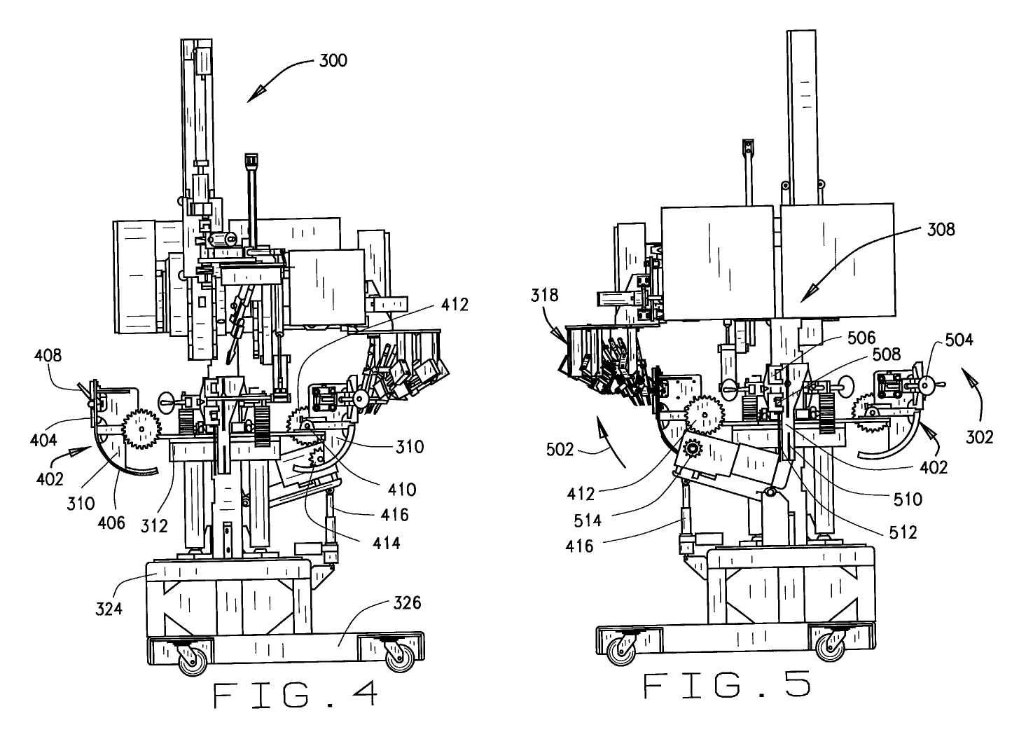

However, prior to separating the meat from the bone, the sub-primal cut must be first attached to a mounting fixture that will hold and manipulate the piece of meat during the process of separating the meat from the bone. One embodiment of the fixture described herein is also designed to take advantage of the weight of the sub-primal cut of meat by using gravity to assist in separating the meat from the bone. The mounting fixture is designed to secure the meat in a vertical position in such a manner to allow the meat already severed from the bone to hang down and create a tension at the meat and bone interface to facilitate the cutting process. As noted above, the blade bone is removed from the chuck blade work item prior to being operated on by the invention. Also, fixing the sub-primal cut in a vertical position should also assist in positioning the bones in a substantially straight line to facilitate separation of the meat from the bone. The details of the mounting fixture will be discussed further when discussing FIGS. 4, 5 and 6.

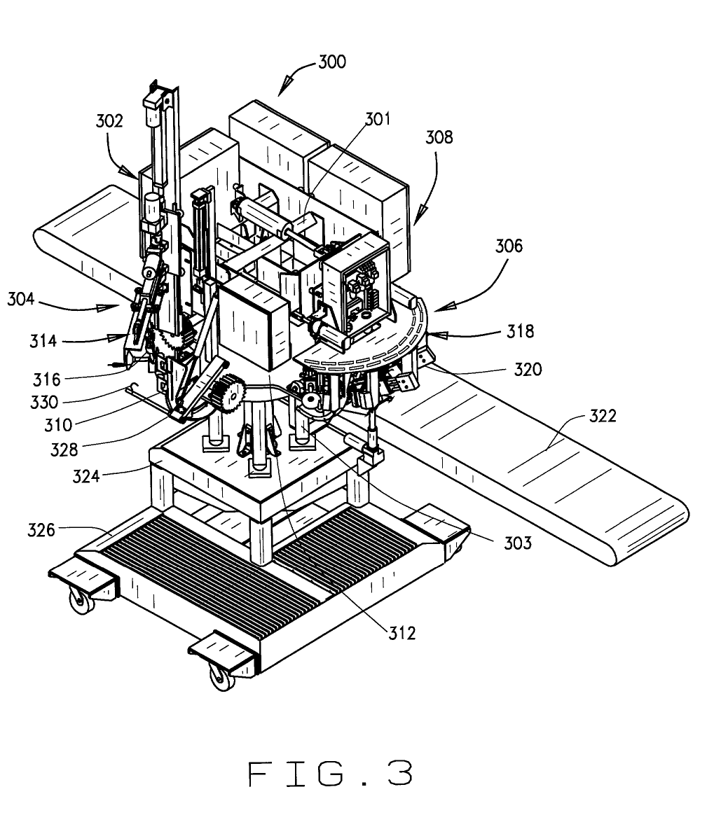

Referring to FIG. 3, a perspective view of an embodiment of the invention is shown. A carousel layout of the chuck blade de-boning machine 300 is shown. The chuck blade de-boning machine 300 further comprises four stations, including the mounting station 302 (which is not clearly seen from this view), the rib bone removing station (rib de-boning station) 304, the neck bone removing station 306 (neck de-boning station) and a spare station 308 which cannot be clearly seen from this view. The spare station can optionally be used as a dismount station for dismounting the remaining bone when the meat has been separated. The four stations are mounted to a center support structure 301 and extend therefrom and said center support structure is mounted on and extending up from main platform 303. The mounting station 302 is the position where the sub-primal cut of meat is mounted on the mounting fixture that holds and positions the meat during the bone separation process. There are a plurality of mounting fixtures 310 attached to a rotation table 312 in a carousel assembly pattern where the rotation table is adapted to rotate in such a manner to position a mounting fixture in an appropriate position adjacent a station such as the neck bone removing station 306. The number of mounting fixtures is preferably equivalent to the number of stations around the carousel pattern such that there can be a mounting fixture positioned adjacent each station simultaneously. This will allow each of the stations to operate simultaneously. The rib de-boning station 304 includes a rib de-boning assembly 314 which further comprises a reciprocating rib de-boning chisel blade assembly 316. The neck station 306 includes a neck de-boning assembly 318 which further comprises an array of reciprocating neck de-boning chisel blade assemblies 320. Also in FIG. 3 a conveyor belt 322 is shown which can be utilized to carry the sub-primal portions of meat to the de-boning machine for mounting at mounting station 302 and can be used to carry away bone structure remnants once the desired meat is removed and the bone remnant is dismounted at the dismount station. The rotation table and main platform are mounted on a primary support table 324. The support table is further mounted to a counter balance platform 326 that is designed to offset the majority of its weight on the sides of the rib station and the neck station. This has a counter balancing effect to reduce vibration caused by the chisel blade assemblies during operation. The rib station has an additional optional feature, which is the tensioner assembly 328 having a hook tensioner 330. The tensioner assembly is utilized to continuously provide additional tension at the meat to bone interface during the bone removal process by hooking the hook tensioner 330 in the meat and pulling down on the meat with sufficient force. A similar hook tensioner can be utilized at other de-boning stations, but is only shown at the rib bone station for this embodiment.

Referring to FIG. 4, a side view of the chuck blade de-boning machine 300 is shown. To the left of this view, a side view of a mounting fixture 310 is shown. There are two other mounting fixtures shown in this view. One is to the right of this view and one is central to this view. The mounting fixture includes a mounting panel 402 having an upper flat straight panel portion 404 and a lower arched panel portion 406. The flat straight portion of the panel further includes a hooking member 408 on which the sub-primal cut of meat is hung. The hooking member shown is a spike or dagger pin that extends outwardly at an upward angle from the upper portion of the flat straight panel portion.

The chuck blade sub-primal cut has five thoracic vertebrae where each halved vertebra having an opening in the inner wall of the spinal canal to a channel that extends therethrough each halved vertebra. The outwardly extending spike is typically inserted through the opening to the channel of the fourth thoracic vertebra thereby hanging the chuck blade sub-primal cut meat portion. The chuck blade is hung such that the fifth thoracic vertebra is at the top facing upward. The chuck blade sub-primal cut is hung in this manner because the meat is first removed at the rib station starting at the fifth thoracic vertebra and working downward toward the neck bone skeletal structure. Once the meat is mounted on the mounting fixture 310, the rotation table 312 and the attached mounting fixture 310 with meat mounted thereon is adapted to transition the sub-primal cut of meat to a position adjacent a station such as the rib de-boning station where the rib de-boning station begins its operation to separate the meat from the rib bone. This mounting fixture is adapted to handle and orient meat cuts during the de-boning process thereby eliminating the manually intensive handling of large meat cuts. Please note that as an operator is mounting a meat cut at the mounting station on the mounting fixture, similar meat cuts that were previously mounted at the mounting station on separate mounting fixtures can now be positioned at the rib station and the neck station mounted on separate mounting fixtures where meat separation operations are being performed. Therefore, transitioning to the next station a mounting fixture on which a meat cut has just been mounted is not performed until all stations indicate ready. The counterbalance platform 326 is further illustrated in this view as it is clearly illustrated that the platform extends out from the support table on the side of the neck station providing a counterbalance weight on that side.

The mounting fixture 310 has a tubular member that is adapted to rotate on axle bearing member 410. The ability to rotate about axle bearing member 410 allows the mounting assembly to be rotated upward to position the meat cut optimally for removing meat from the bones. The rotation is caused by engaging a mounting assembly gear 412 and a drive gear 414 for driving the mounting assembly gear. The drive gear is raised with a telescoping arm 416 to engage the mounting assembly gear 412. Once engagement is established, the drive gear can be driven thereby causing the mounting assembly to rotate upward sequentially exposing the vertebra to meat interface in a substantially tangential relationship to the reciprocating blades. For this embodiment, this is the only station for this embodiment where this feature is utilized, however, other stations can be adapted to utilize this or a similar feature.

Meat separation begins at the rib station as the meat is separated from the rib bone starting at the fifth vertebra and working downward toward the neck bone, the weight of the meat falling outwardly and away from the bone tends to pull each bone in the vertebrae structure in a straight line thereby facilitating removal of the meat from the bone. When the meat is being removed from the rib bones which are generally lying against the upper straight portion of the panel, the panel is oriented as shown with the straight portion of the panel in a vertical position. When removal of the meat from the rib bones is completed, the rotation table and attached mounting assembly on which the primal cut is mounted can transition the sub-primal cut to a position adjacent the neck de-boning station where the neck de-boning assembly begins its operation. The transition occurs when all stations indicate they are ready. The mounting fixture having a tubular bearing member rotatable about a bearing such that the mounting panel can be rotated upward about the tubular bearing as the neck de-boning assembly is operating to remove the meat from the neck bones. The sub-primal cut mounted on the mounting fixture 310 is gradually rotated upward toward the array of neck de-boning chisel blade assemblies in a substantially tangential manner as the meat is separated from the neck bone. The neck bone structure generally lies against the curved portion of the panel as it is rotated upward thereby promoting the vertebrae to arch outward and bend away from each other to facilitate removal of the meat from the crevices between the vertebrae. The drive gear 414 for rotation of the mounting fixture is engaged with the mounting assembly gear to effect rotation.

Referring to FIG. 5, an opposing side view of the de-boning system is shown. The spare station, or the dismounting station 308, is shown. It is at this station that the bone remnant may be removed from the mounting panel and discarded as necessary. Also shown in this view is a timing gear 514 and the mounting assembly gear 412. The drive gear not seen in this view is elevated by telescoping arm extension member 416 to engage the mounting assembly gear 412. The drive gear drives rotation of the mounting assembly gear which is operably attached to the mounting fixture thereby causing the mounting assembly to rotate upward as illustrated by Arrow 502 in a substantially tangential relationship to the de-boning assembly 318. The timing gear 514 is utilized to align the drive gear with the mounting assembly gear and for speed control of the drive gear.

A side view of mounting station 302 is also shown. Again, it is at this station that the meat cut is mounted on mounting panel 402. Once the meat cut has been mounted on mounting panel 402, clamping assembly 504 is engaged to further secure the meat on the mounting panel 402. The clamping members 506 and 508 are the members that actually engage the bone structure of the meat cut. The clamping members 506 and 508 are adjustably engaged in the meat cut bone structure further securing the meat cut against the mounting panel. The clamping members 506 and 508 have some degree of float such that the various sizes of meat and contours of the bone structure can be accommodated. The mounting panel disposed adjacent the spare or dismounting station 308 illustrates further features of the mounting panel. The mounting panel 402 has a raised ridge 510 that extends from top to bottom. The raised ridge 510 has a serrated or toothed facing edge. The raised ridge is designed and positioned such that the spinal canal of the sub-primal meat cut can be aligned over the raised ridge. The serrated or toothed edge will tend to penetrate and grasp the interior wall of the spinal canal thereby reducing sideways motion of the meat cut. Mounting panel 402 also has a raised edge 512 where the raised edge has a serrated inner edge such that it will penetrate and grasp the meat cut such that it further prevents sideways motion of the meat cut during the meat removal operation.

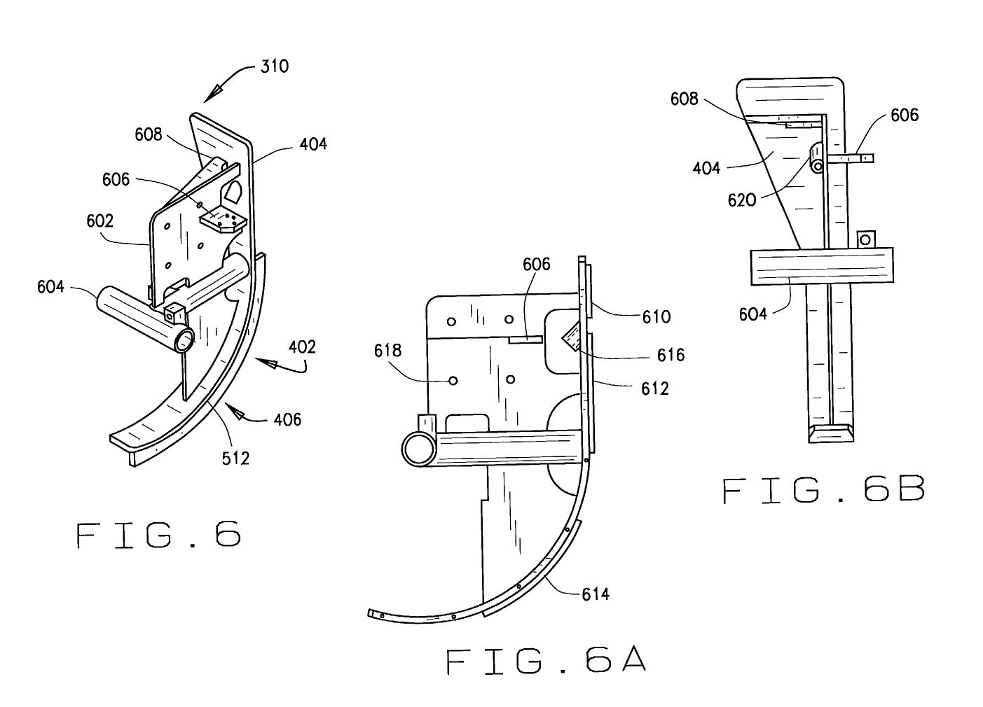

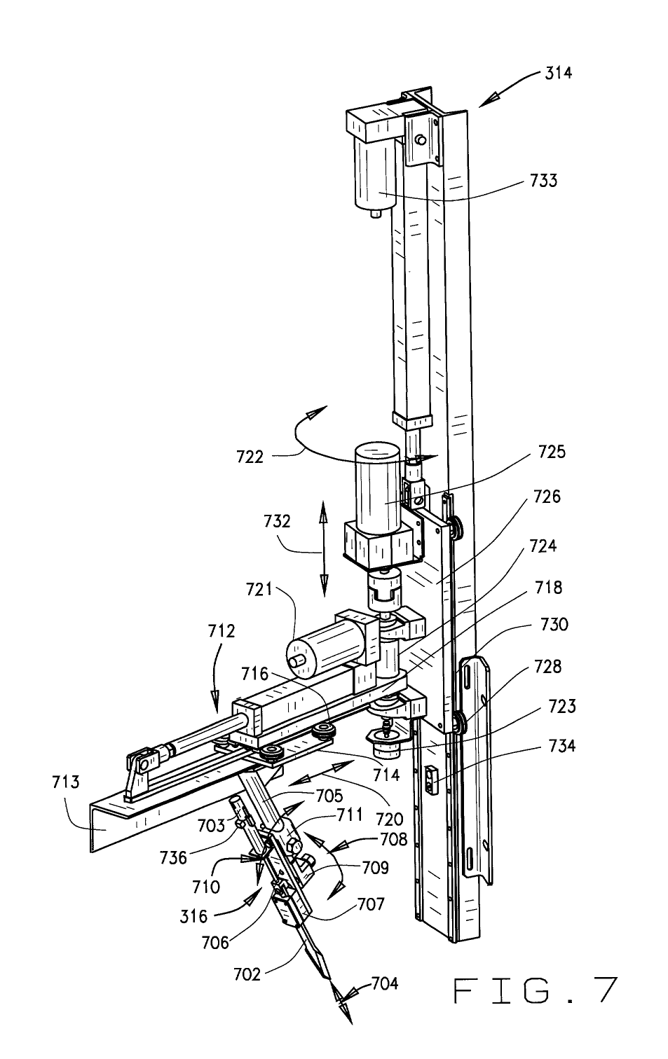

Referring to FIG. 6, a rear side perspective view of the mounting fixture 310 is shown. The mounting fixture 310 further comprises a mounting panel 402 that has an upper flat straight panel portion 404 and a lower arched panel portion 406. This mounting panel is designed to accommodate the two primary bone structures of the chuck blade sub-primal cut. The upper flat panel portion 404 is designed to accommodate the rib bones and associated feather bone structure, while the lower arched panel portion 406 is designed to accommodate the neck bone structure of the chuck blade sub-primal cut. The upper panel flat portion 404 is flat to accommodate the generally flat anatomy of the rib bone structure. The upper panel flat portion is also designed with an outward taper that increases the facing surface of the upper panel portion such that it can better support feather bones which may be attached to the rib bone structure. The direction of the taper can be on an opposing side to accommodate a chuck blade sub-primal cut taken from the opposing half of the beef carcass. The taper of the upper panel portion can be clearly seen by viewing FIG. 6B.

The lower arched panel portion 406 is designed with an outward arch for the neck bone structure of the chuck blade sub-primal cut. The outward arch causes the neck bone vertebrae to separate and protrude outward in an arched fashion thereby facilitating removal of meat in the crevices between the vertebrae of the neck bone structure. The mounting panel 402 has a support bracket 602 and 608. The support bracket is further attached to a tubular bearing member 604. The tubular bearing member 604 is adapted to rotate about axle and bearing member 410 as shown in FIG. 4.

Further referring to FIG. 6A, mounting points 618 are shown where the clamping assembly 504 can be mounted. Further, latch mount member 606 is shown, which is a mount for a latching member for the clamping assembly 504. Further referring to FIG. 6B, a rear view of mounting pin receptacle 620 is shown. A mounting pin from which the meat cut is hung, is inserted at an angle into this mounting pin receptacle. One embodiment of the mounting pin is a straight dagger pin which can be inserted through bore 616 of receptacle 620. FIG. 6A also shows that the center raised ridge 510 comprises three central raised ridges—upper, middle and lower ridges 610, 612 and 614. The central ridges 610, 612 and 614 extend partially along the length of the mounting panel and substantially centered side-to-side. The central ridges 610, 612 and 614 have a serrated facing edge. The ridges are positioned such that it can be aligned with and positioned in the spinal canal of the chuck blade sub-primal cut of meat. The edge of the raised ridges having a serrated edge or teeth will assist in preventing lateral movement of the sub-primal cut. A raised edge 512 that has a serrated inner edge having teeth such that lateral movement of the chuck blade sub-primal meat cut is restricted. The raised edge 512 extends partially along the length of the arched portion of the mounting panel along one side. The serrated edge or teeth point inward toward the center portion of the mounting panel.

Referring to FIG. 7, a top-side perspective view is shown of the rib de-boning assembly 314 and the rib de-boning chisel blade assembly 316 that is designed to be operably mounted at the rib de-boning station 304 as shown in FIG. 3. As noted above for one embodiment of the invention, when the sub-primal cut is mounted on the mounting fixture the rotation table then transitions the mounting fixture to a position adjacent the rib de-boning station. Referring to FIG. 7, the mounting fixture 310 is not shown adjacent the rib de-boning assembly 314. The reciprocating rib de-boning chisel blade assembly 316 is shown operatively attached to the rib de-boning assembly 314. The chisel blade 702 is also shown and the direction of the reciprocating action is shown by arrow 704. The chisel blade 702 is operatively connected to the chisel blade head assembly bracket 706 which mechanically, electromechanically, hydraulically, pneumatically and/or otherwise extends the chisel blade 702 outward from the chisel blade head assembly as indicated by arrow 704 and retracts the chisel blade as indicated by arrow 704 with a repetitive reciprocal action. The reciprocating action of the chisel blade extends the blade outward to stab and penetrate the targeted section of meat that is directly attached to the bone structure and retracts the blade repeatedly while traveling side-to-side thereby severing the meat from the bone, primarily with the sharpened sides of the chisel blade. The repetition of the stabbing and penetrating action of the chisel blade, along with side-to-side motion, separates the meat from the bone. The slide bearing 707 as shown is used to guide the direction of the reciprocating blade. The reciprocating action is actuated by a chisel blade actuator piston assembly 703. The chisel blade head assembly 706 is further mounted on a bushing extension arm 705 by torsion bushing 709 and torsion bushing 711. Torsion bushing 711 provides compliance as indicated by arcual arrow 710 and torsion bushing 709 provides compliance as indicated by arcual arrow 708.

Arcual arrows 708 and 710 show the compliant action along a direction of compliance of the chisel blade head assembly. Arcual arrow 708 reflects a rotational compliancy laterally and arcual arrow 710 shows rotational compliancy vertically along their respective directions of compliance. The rib de-boning chisel blade assembly bushing extension arm 705 is operatively attached to positioning arm 712 by roller plate 714 and bracket 713. The roller plate 714 has four track wheels 716 that track along a track panel 718. The interface between the track wheels 716 and the track panel 718 allow the reciprocating rib de-boning chisel blade assembly 316 to radially reciprocate along the track panel 718 in a direction as indicated by arrow 720. The radial reciprocation as indicated by arrow 720 is actuated by power source 721. The power source can be a motor or other appropriate power source.

The attached combination of the rib de-boning chisel blade assembly 316 and the positioning arm 712 is adapted to rotationally pivot as indicated by arcual arrow 722 about a vertical axis defined by positioning arm pivoting assembly 724. The positioning arm 712 is attached to a positioning arm pivoting assembly 724 which affects the rotational pivoting action of the positioning arm 712 and attached reciprocating rib de-boning chisel blade assembly combination. The rotational pivoting action as indicated by arcual arrow 722 is actuated by power source 725. The rotational position can be sensed by a rotational sensor 723. The positioning arm pivoting assembly 724 attaches the positioning arm to a vertical roller plate 726. The vertical roller plate 726 has four track wheels 728 which track along vertical track panel 730. The vertical track plate affects the up and down vertical reciprocation of the rib de-boning chisel blade assembly as indicated by arrow 732. The up and down vertical reciprocation as indicated by arrow 732 is actuated by power source 733. The assembly may reciprocate fully downward to a hard stop 734.

The multimember rib de-boning chisel blade assembly with its various ranges of motion affect the severing of the meat from the rib bone skeletal structure. As indicated, this is accomplished by the reciprocating action of the chisel blade 702 plunging into the meat with a stabbing action and retracting while moving side-to-side thereby severing the meat from the bone, primarily with the sharpened sides of the blade. However, the cutting action is facilitated and made more effective by the built in compliancy as indicated by arrows 708 and 710, which allows the reciprocating chisel blade to follow along the varying contours of the bone structure without the chisel blade becoming bound or embedded. There is also compliancy in the direction of arrow 704 due to the compliancy in the cylinder when the blade extends striking a hard object. The roller plate 714 and track wheels 716 affect a longitudinal reciprocation of the rib de-boning chisel blade assembly 316 as indicated by arrow 720 in order to accurately position the reciprocating rib de-boning chisel blade such that it is longitudinally positioned to sever the meat from the bone. The rotational pivoting action as indicated by arrow 722 is affected by the positioning arm pivoting assembly 724 which again affects the arcuate positioning of the chisel blade with respect to the meat and bone structure.

To initiate the meat separation operation, the chisel blade can be positioned such that its cutting edge is positioned at the base of the fifth feather bone where it joins the fifth rib bone to initiate the cutting cycle. The chisel blade initially travels side-to-side while reciprocating the blade severing the meat to bone interface at a given planar level. When the meat and bone interface is severed, the chisel blade steps down to the next planar level and continues the repetitive side-to-side travel while continuing reciprocation of the chisel blade. As the meat is severed from the bone starting at the fifth thoracic vertebrae, the reciprocating chisel blade assembly moves downward toward the first thoracic vertebrae while cycling side-to-side until all meat has been separated from the rib bone structure. The vertical downward movement from the fifth thoracic vertebrae toward the first thoracic vertebrae is affected by the vertical roller plate 726 as indicated by arrow 732. The side-to-side motion is substantially arcual about the mounting fixture and is affected by pivoting assembly 724 and roller plate 714. The specific side-to-side arcual pattern can be controllably adjusted to vary the arc or the distance traveled side-to-side.

The roller plate 714 that tracks radially is powered by a radial track power source 721. The rotational pivotal motion of the positioning arm 712 as affected by the positioning arm pivoting assembly 724 is powered by rotational power source 725 as noted previously. The positioning arm pivoting assembly 724 is attached to vertical roller plate 726 which affects the up and down motion of the rib de-boning chisel blade assembly. The vertical roller plate 726 is powered by vertical track power source 733. Each of the power sources is adapted to be controlled by an automated control system. Therefore, the operation of removing the meat from the rib bone structure can be adapted to be fully autonomous or semi-autonomous with minimal or no manual interaction. Also, the specific cutting pattern and sequence may be controllably adjusted to accommodate a specific bone structure. The rib de-boning chisel blade assembly can be adapted to perform a preprogrammed sequence of movements that will affect the removal of the meat from the rib bone structure by preprogramming the control system. This autonomous sequence of movements will be discussed further when discussing the controller function of this invention. The power sources 721, 725 and 733 can be adapted to be electromagnetic, pneumatic, hydraulic, or any other appropriate power source that can be controlled by a controller to affect the various maneuvers as illustrated by the arrows.

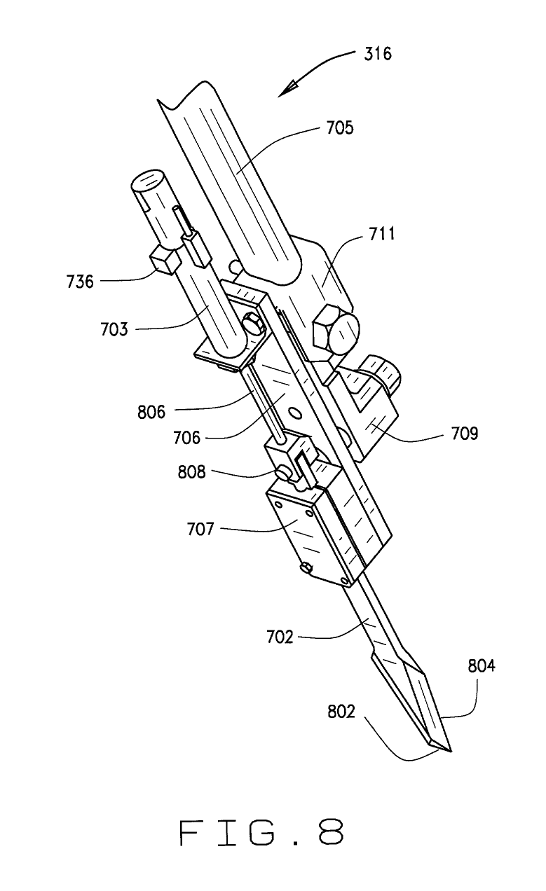

Referring to FIG. 8, a detailed perspective view of the reciprocating rib de-boning chisel blade assembly 316 is shown. The chisel blade 702 has a beveled tapered cutting edge 804. The cutting edge 804 is adequately sharpened to sever the meat from the bone as the blade extends and retracts repeatedly with a reciprocating action. The blade tip end 802 of the chisel blade 702 is substantially unsharpened such that the blade end 802 does not chip or cut away the bone structure. The blade 702 extends through slide bearing 707 and is removably attached to joint member 808. Joint member 808 can be designed to quickly engage and disengage the blade 702 such that the blade can be quickly removed for maintenance such as sharpening. Joint member 808 is attached to piston rod 806 which extends from the actuator piston cylinder assembly 703.

Sensor 736 is adapted to sense how far blade 702 is extended. This sensor is communicably linked to a controller that utilizes the output of the sensor to determine if reciprocation of the chisel blade has halted. A halting of the reciprocating action can be an indication that the chisel blade reciprocating action is being obstructed and that the chisel blade is bound, thereby preventing reciprocating action. When the control system receives this input, corrective measures are taken to free up the chisel blade. For example, the control system can attempt to fully retract the chisel blade by communicably controlling cylinder 703 and also fully retract the entire chisel blade assembly 316 including the chisel blade head assembly bracket 706 by communicably controlling and retracting the roller plate 714 and the four track wheels 716 as shown by FIG. 7. Exercising the two retractions should free up the chisel blade. Proximity sensor 736 is adapted to also detect if the chisel blade is fully extended without obstruction (bottomed out).

The chisel blade assembly 316 has two additional sensors that sense the angle of orientation of the blade with respect to bushing members 709 and 711. One sensor detects the lateral rotation of the blade with respect to bushing member 709. A second sensor senses the vertical rotation of the blade with respect to bushing member 711. Bushing members 709 and 711 provide compliance for the chisel blade assembly such that when the blade is severing the meat from the bone, the blade does not cut into the bone structure and the compliance should also assist in preventing the chisel blade assembly from getting bound and thereby hindering the motion of the chisel blade assembly. If the chisel blade is laterally rotated to a left or right position and remains in a fixed position of rotation, this can be an indication that motion of the chisel blade is being inhibited because of the chisel blade being bound. The compliant torsion bushings should always return the chisel blade to its nominal central position when not being obstructed or forced in one direction. The sensor for detecting lateral rotation is also communicably linked to the controller system such that if the controller system receives an indication from the sensor that the blade is fixed in a right or left position, the controller system will take corrective measures to free up the blade. For example, the blade can be fully retracted and the chisel blade assembly can be backed away from the meat cut by retracting the assembly with horizontal roller plate 714 as described above. Once the blade is free, the cutting process can continue. Similarly, the sensor for bushing member 711 senses the vertical rotation of the blade with respect to bushing member 711. The sensor for vertical rotation with respect to bushing member 711 is communicably linked to the control system. If the control system receives an input from the sensor that the blade is rotated up or down and remains in a fixed position of rotation, the control system will assume that the blade motion is being obstructed due to being bound. The blade and the chisel blade assembly will be retracted as described above to free up the chisel blade.

If a compliance/positioning-sensing indicator is provided, the controller may respond differently depending on the cutting operation that is currently being performed. For example, when the rib de-boning chisel blade assembly is removing meat from the rib bone structure, if a knuckle is encountered during a rotational motion of the chisel blade assembly, the chisel blade assembly will likely pivot laterally and the chisel will bias full to the left or to the right of center and the corresponding control signal will be provided to the controller. When this situation occurs, the controller will provide control functions that will correct the position of the chisel blade assembly to avoid cutting into the bone or binding the chisel. To correct position, the controller will control the chisel blade assembly to climb vertically upward the knuckle while moving in a minus radial direction and while fully retracting the blade. Another example is when a knuckle is encountered during an elevational change such that the chisel blade assembly is moving vertically. During this scenario, the chisel blade assembly will likely bias to a full up position and a control signal indicating such will be provided to the controller. The controller can correct the position of the chisel blade assembly by vertically climbing up the knuckle while moving in a minus radial direction and while retracting the chisel blade. A third example is when the chisel blade bottoms out (when the chisel blade has fully extended outward without obstruction) to its fully extended position which can possibly be encountered when moving the chisel blade assembly vertically or radially. The controller can correct the position of the chisel blade assembly by reversing the movement and this situation may be utilized to sense a limit of motion on either the vertical or radial axis.

During general operation, the rib de-boning chisel blade assembly begins reciprocation and then the chisel moves positive on the vertical axis and then the chisel moves about the rotary axis in a clockwise positive motion through the full range of travel. Then the chisel moves about the rotary axis in a minus direction returning to the channel area adjacent the feather bones. Prior to rotating negatively on the rotary axis, the chisel head will move negatively on the vertical axis so that it clears the bone upon rotation. This cycle is repeated until the meat has been completely severed from the rib bone structure.

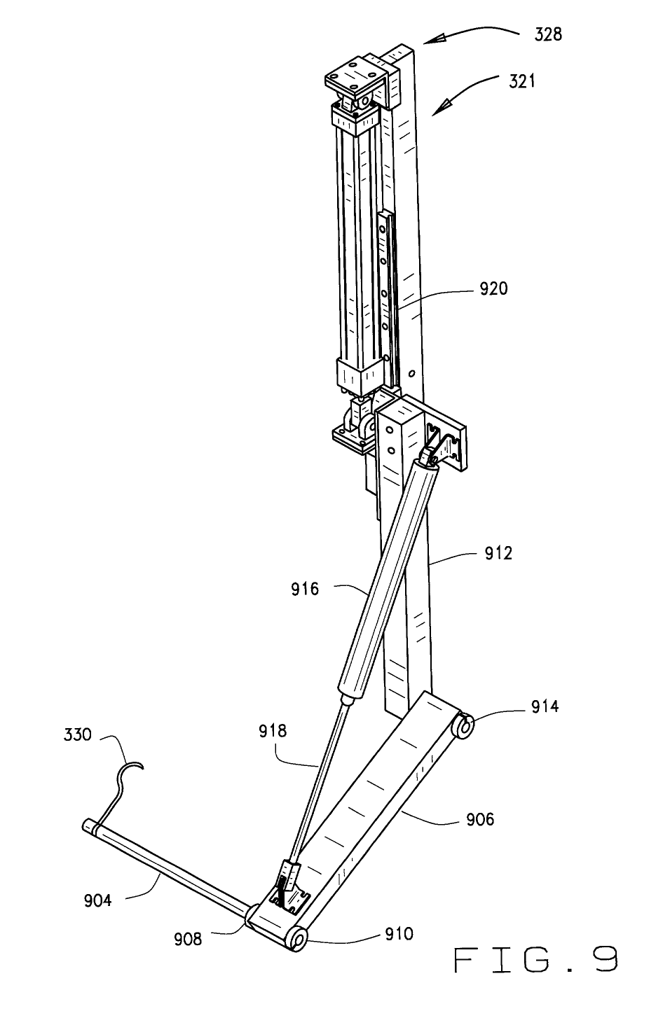

Referring to FIG. 9, a detailed perspective view of the tensioner assembly 328 is shown. Severing meat from the bone structure is facilitated by maintaining an adequate tension at the exposed meat-to-bone interface where the chisel blade is directed. The meat-to-bone interface is severed by the chisel blade separating the meat from the bone. Severing is facilitated by the cutting edges of the chisel blade, as well as the angle of extension of the chisel blade as is represented in FIGS. 7 and 8. The severing action is further facilitated by maintaining a tension at the meat-to-bone interface. This tension is substantially maintained by the weight of the meat as it is separated from the bone because the meat falls away from the bone and hangs downward thereby maintaining tension at the meat-to-bone interface. Further tension can be optionally maintained by a device which applies a downward pulling action to increase the tension at the meat-to-bone interface. One embodiment of such a tensioning device is the tensioner assembly 328 as shown in FIG. 9.

The tensioning assembly 328 has a hook tensioner 330 that can be hooked into the meat in order to exert a downward pulling action for providing additional tensioning at the meat-to-bone interface. The tension hook is attached to an extension rod 904 which is further rotatably attached to a tensioning arm 906. The rod 904 is rotatably attached to one end of tensioning arm 906 by bearing members 908 and 910. The rotatable interface between the extension rod 904 and one end of the tensioning arm 906 can be spring-loaded such that a rotational force is applied to the extension rod 904 and thereby transferred to hook tensioner 330. The opposing end of tensioning arm 906 is hingedly attached to one end of the downward hanging bracket assembly 912 by bearing member 914. The hinged interface between the tensioning arm and the downward hanging bracket 912 can be spring-loaded such that a rotational force is applied to the tensioning arm 906. A piston rod and cylinder assembly 916 is attached to the opposing end of the downward extending bracket 912 and extends to and attaches to the tensioning arm 906 proximate the interface between the extension rod 904 and the tensioning arm 906. The piston rod 918 is adapted to extend downward to engage the tension hook 330 in the meat applying a downward force. The piston rod and cylinder can be powered by an appropriate power source. The downward hanging bracket 912 can also be vertically adjusted up or down along track rail 920.

In summary, for the portion of the present embodiment of the invention as described above, which is adapted to separate meat from the bone structure of a chuck blade sub-primal cut or other similar meat cuts, the chuck blade sub-primal cut is initially mounted at the mounting station 302. The chuck blade sub-primal cut is mounted by insertion of a dagger pin through the opening of a channel of the fourth thoracic vertebrae. The dagger pin extends with an upward angle from the upper portion of the flat straight panel portion of the mounting panel. The sub-primal cut can optionally be hung from the fifth or third thoracic vertebra each having an opening to a channel that extends therethrough. Once the sub-primal cut is mounted on the dagger pin with the fifth thoracic vertebra pointing upward, the clamping members can be engaged with the bone structure to further secure the sub-primal cut to the mounting panel. The sub-primal cut is mounted such that the fifth thoracic vertebra is pointing upward such that the rib bone structure is supported by the flat straight panel portion and the neck bone structure is supported by the lower arched panel portion. Once mounting is completed, the sub-primal cut can be transitioned to the rib de-boning station 304 when all stations indicate ready. This is accomplished by rotating the rotation table and the mounting fixture attached thereto such that the newly mounted sub-primal cut is transitioned to a location adjacent the rib de-boning station. The rib reciprocating de-boning chisel blade assembly initiates the cutting operation by positioning the edge of the chisel blade at the base of the feather bone at the feather bone and rib bone joint. The reciprocating action of the chisel blade can then be initiated along with the side-to-side rotational sweeping action of the chisel blade assembly. The chisel blade assembly will cycle back and forth in an iterative fashion while the blade is reciprocating. Once the chisel blade assembly has cycled side-to-side a preset number of times inducing separation of meat from the bone structure at a given level, the chisel blade is lowered a preset distance while continuing to cycle side-to-side and reciprocate. The chisel blade assembly is controlled to iteratively repeat this process until it is transitioned downward from the fifth thoracic vertebra to the first thoracic vertebra. When the apparatus has completed removing the meat from the rib bone structure, the rib de-boning chisel blade assembly returns to its stowed position (chisel blade fully retracted; horizontal track plate retracted fully away from meat cut; and vertical track plate retracted vertically upward). At this point, the tensioning device disengages and returns to its stowed position. When all stations indicate ready, the carousel assembly or rotation table rotates the mounting fixture with the chuck mounted thereon to a position adjacent the neck de-boning station. When the mounting fixture and the chuck blade mounted thereon having its meat separated from the rib bone structure (hanging downward and away from the bone) is positioned adjacent the neck de-boning station, the neck de-boning assembly is pivoted downward into its engage position.

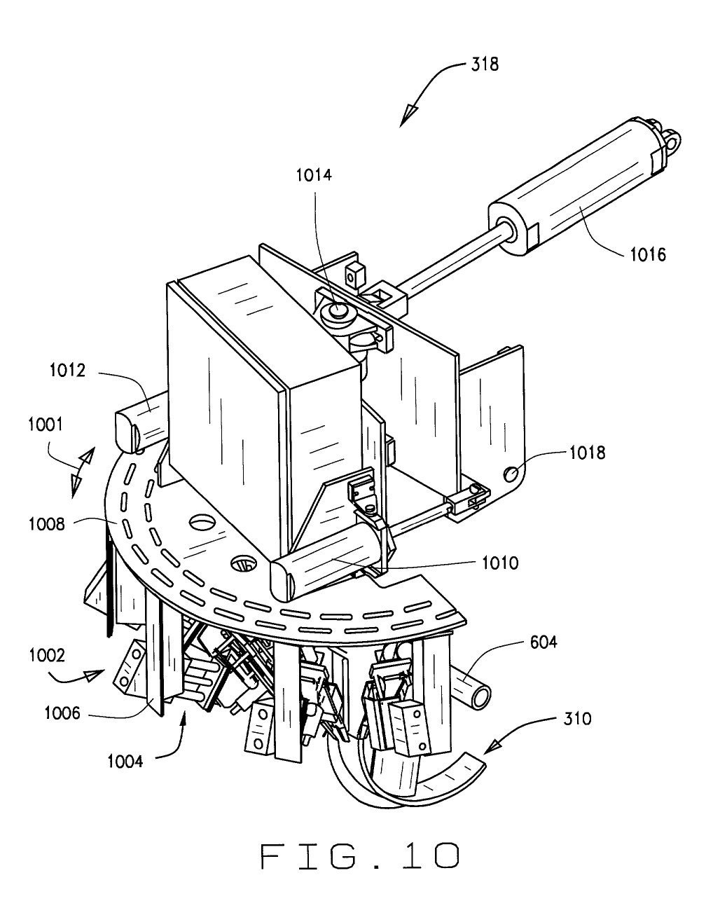

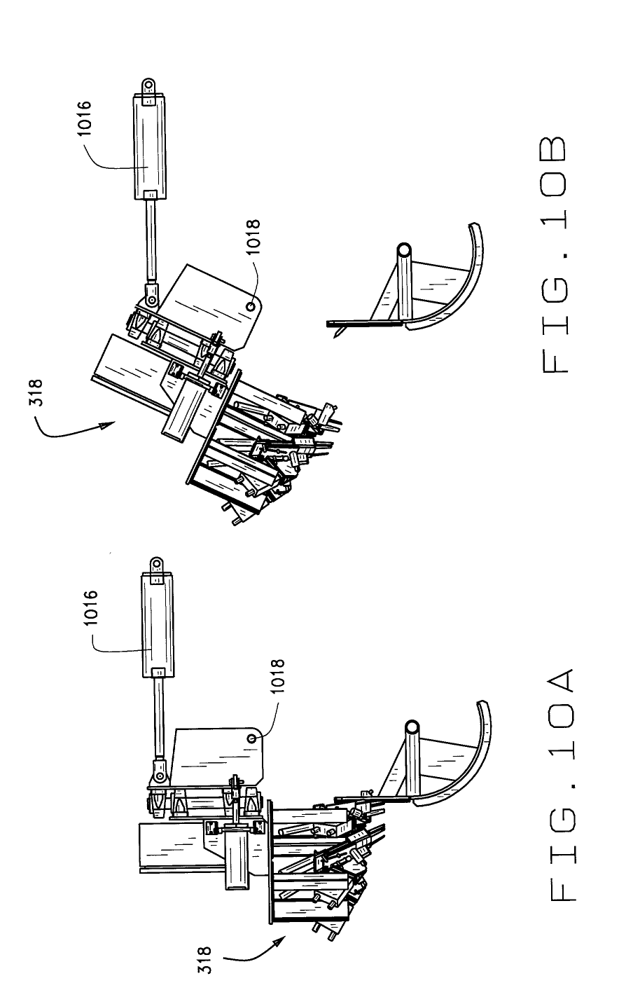

Referring to FIG. 10, a top side perspective view of the neck de-boning assembly 318 is shown. In this figure, a mounting fixture 310 is shown for illustrative purposes at the neck de-boning station adjacent the neck de-boning assembly 318. The neck de-boning assembly 318 comprises a neck de-boning chisel blade array 1002 which includes a plurality of neck de-boning chisel blade assemblies 1004. The neck de-boning chisel blade assemblies 1004 are mounted on downward extending brackets 1006 which are further mounted to a rotational plate 1008. The array of neck de-boning assemblies are huddled about the mounting fixture position and are further oriented such that the chisel blades are pointing inwardly and down toward the mounting fixture position. The neck de-boning assembly 318 as shown in FIG. 10 is further equipped with two array rotation actuators 1010 and 1012. The array rotation actuators are adapted to rotate the array of neck de-boning chisel blade assemblies about an array rotation pivot 1014. The neck de-boning assembly 318 as shown in FIG. 10 is further equipped with an array retraction actuator 1016 which is adapted to rotationally retract and engage the assembly about the array retraction center pivot 1018. The neck de-boning assembly 318 is mounted at the neck de-boning station 306. The semi-circular geometry of the neck de-boning rotational plate 1008 defines the semi-circular arrangement of the plurality of neck de-boning chisel blade assemblies attached thereto. This embodiment described herein shows five neck de-boning chisel blade assemblies. The neck de-boning rotational plate also defines the arcual sweeping pattern of the neck de-boning chisel blade assemblies as they sweep around the mounting fixture having the sub-primal cut of meat mounted thereon, positioned adjacent the neck de-boning assembly. The neck de-boning rotational plate is adapted to rotate as shown by Arrow 1001 about the rotational plate array rotation pivot 1014. The rotation of the rotational plate is affected by a pair of actuators which extend and retract thereby rotating the pivot plate and the neck de-boning chisel blade assemblies attached thereto about the mounting fixture positioned adjacent to the neck de-boning station.

When the sub-primal cut is transitioned to the neck de-boning station, the meat has already been separated from the rib bone structure and the separated meat is hanging downward and away from the bone structure. The weight of the meat hanging down will tend to straighten the naturally curved neck bone structure and thereby causing the neck bone to lie more flush against the arched portion of the mounting panel. The meat separation process for the neck bone structure can now be performed by the array of neck de-boning chisel blade assemblies. The sub-primal cut is mounted on the mounting fixture 310 adjacent the array of chisel blade assemblies. The array of neck de-boning chisel blade assemblies are rotated about the mounting fixture in an arcual pattern and reciprocating back and forth. As the meat is severed from each section of the cervical vertebra, the mounting fixture is rotated upward in a substantially tangential relationship to the chisel blade assembly as previously indicated in order to continue the severing process on the next section of the cervical vertebrae. The meat separation begins at the seventh cervical vertebra and continues to the first cervical vertebra until the meat is completely removed from the neck bone structure. The neck de-boning assembly stops the de-boning process when the mounting fixture has rotated upward to its maximum rotary travel position which is indicative that the meat has been completely removed from the neck bone structure.

As indicated, the chisel blade assemblies will iteratively cycle back and forth in an arcual fashion as the neck de-boning chisel blades are extending outward and retracting in a reciprocating fashion and as the mounting fixture is rotating upward about the tubular bearing member 604. The upward rotation of the mounting fixture facilitates a separation of meat from the neck bone structure. The upward rotation of the mounting fixture is helpful because as the mounting fixture is rotated upward, the neck bone structure is supported more by the lower arched portion of the mounting panel, which arches the vertebrae outward and separates them. The individual chisel blades extend and retract independently in a reciprocating fashion and they rotate about the sub-primal cut in an arcual fashion while the mounting fixture is rotating upward such that the entire length of the neck bone structure is rotated upward past the extending and retracting chisel blades substantially tangential such that the meat is separated from the bone. Please note that the immediately adjacent chisel blades are preferably not extended simultaneously, however, this may vary depending on the spacing therebetween. Preferably, phased groupings of non-adjacent blades are extended. This embodiment having an array of five are phased into three (3) groups. For example, if the blades are numbered 1-5, blade 1 and blade 3 is a group; blade 2 and blade 4 is a group and blade5 is the last group.

This rotation upward allows the meat to be removed from the neck bone structure starting at the seventh cervical vertebra and on to the first cervical vertebra. The mounting panel fixture is adapted to rotate upward until the upper flat panel portion is substantially horizontal. A proximity sensor can be utilized to sense when this condition has occurred. This motion allows for the meat to be removed from the neck bone structure along the entire length. This upward rotational action also alleviates the need for the array of neck de-boning chisel blade assemblies to transverse downward starting at the planar level of the seventh cervical vertebrae and continuing down to the planar level of the first cervical vertebrae. As the mounting panel fixture is rotated upward the neck bone structure of the sub-primal cut begins to rest flushly against the lower arched portion of the panel fixture. The arched portion pushes the sub-primal meat cut outward in an outward arching manner toward the array of chisel blades while also causing the crevices between the cervical vertebrae to open outward away from one another thereby facilitating the removal of meat from those crevices.

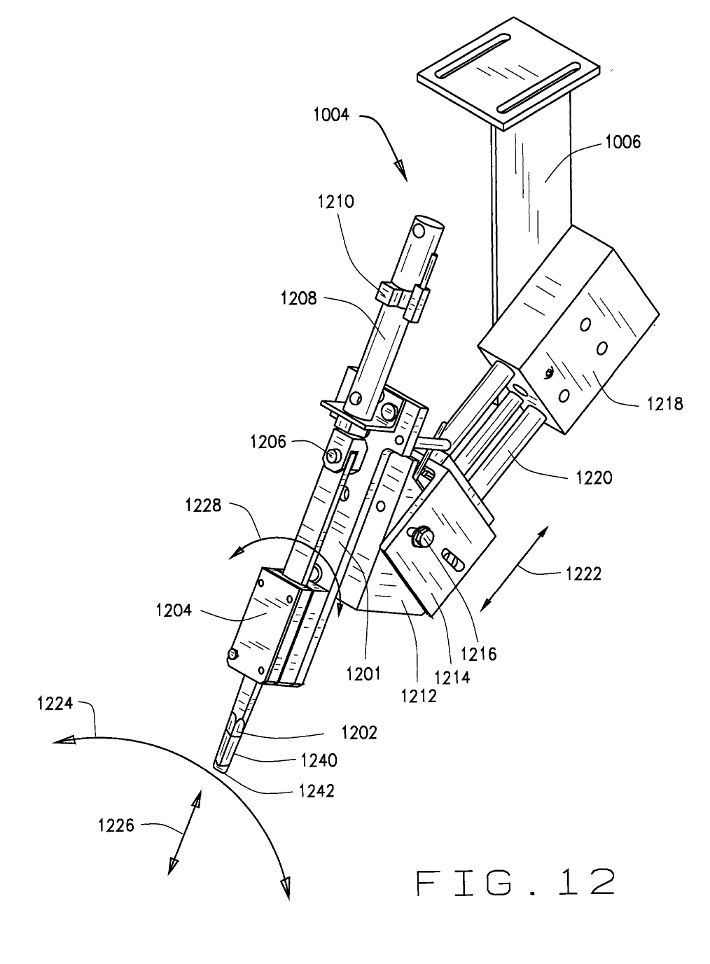

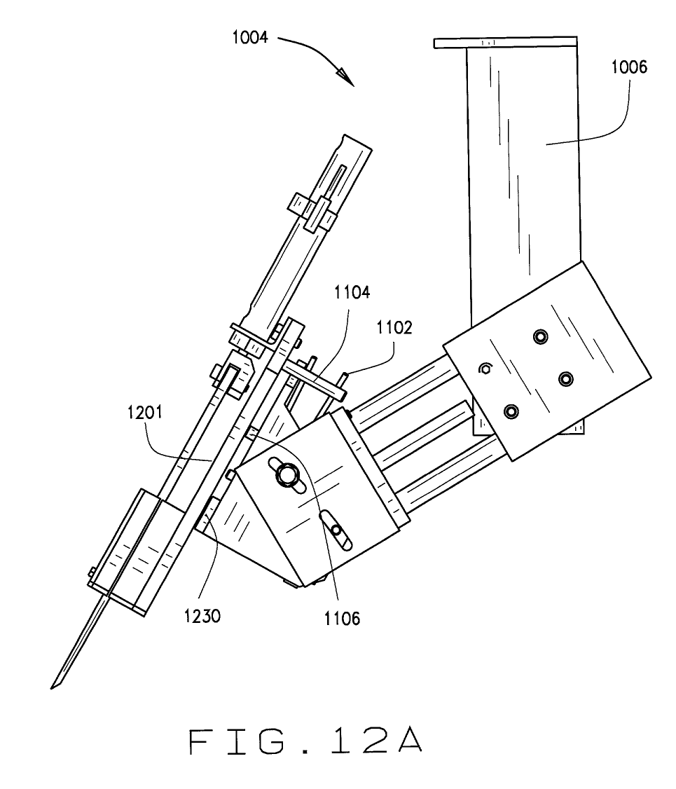

The array of chisel blade assemblies are mounted having a preset angle of extension and arcually arranged such that the meat can optimally be separated from the bone structure. For example, the downward extending brackets are adjustably mounted to the rotation plate 1008. The downward extending mounting bracket 1008 can be arcually adjusted about the rotation plate 1008 at the same or different radii, thereby defining their arc of rotation. Also, the angle of extension is adjustable as described below when discussing FIG. 12.

Referring to FIGS. 10A and 10B, side views of the neck de-boning chisel blade assembly are shown. FIG. 10A shows the neck de-boning assembly 318 in the engaged position. FIG. 10B shows the neck de-boning assembly in its retracted position. The actuator 1016 affects the engage and disengage by pivotally rotating vertically the neck de-boning assembly about retraction center pivot 1018.

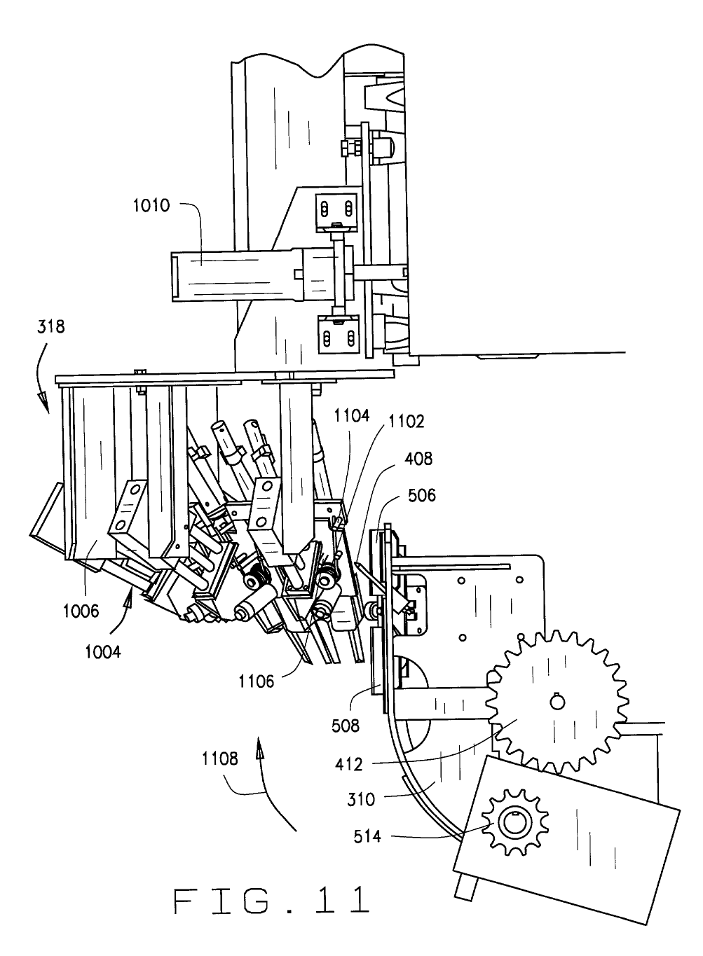

Referring to FIG. 11, a detailed side view of the neck de-boning station is shown. The neck de-boning station includes a neck de-boning assembly 318 which further includes an array of neck de-boning chisel blade assemblies that are mounted to a rotational plate by an downward extending bracket. The neck de-boning station has a mounting fixture 310 positioned adjacent to the array of chisel blade assemblies. The chisel blade assemblies are mounted with a downward angle directed toward the mounting fixture. The downward angle of an extension is adjustably optimized to facilitate removal of the meat from the bone structure. The array of chisel blade assemblies is mounted to the rotation plate in an arcual pattern about the mounting fixture. As noted above, the chisel blade assemblies can be adjustably positioned at the same radius thereby following the same arcual pattern when rotation occurs or can be positioned at different radii to follow different arcual patterns. Further, however, a subset of the array of chisel blades can be grouped in closer proximity with less spacing between each in the grouped subset than between the remaining assemblies in the array. The grouping of certain chisel blade assemblies can be adjusted to accommodate a particular bone and meat structure. For example, three chisel blade assemblies within the array may be grouped in closer proximity than the remaining two chisel blade assemblies on the side where there is a greater density of meat to be removed from the bone structure. Therefore, as the array of chisel blade assemblies sweep side-to-side in an arcual pattern about the mounting fixture, the three chisel blades grouped in close proximity will tend to concentrate on the areas where there is a greater density of meat.

The chisel blade assemblies are designed with compliant features. For example, a rotational lateral compliance is provided by spring member 1102. The function of the spring member 1102 could be performed by other appropriate devices such as torsion bushings. The spring member 1102 applies a compliant force against retention member 1104. The chisel blade assemblies are also equipped with rotational proximity sensors 1106. Sensor 1106 can detect the lateral rotation of the chisel blade. The sensor is communicably linked to a control system that utilizes the output of the sensor to detect lateral rotation that may indicate that the chisel blade is bound, thereby preventing movement.

The side view as shown in FIG. 11 also reveals the timing gear 514 and the mounting assembly gear 412. As previously described when discussing FIG. 4, the drive gear is raised with an arm to engage the mounting gear. Once engagement is established, the drive gear can be driven thereby causing the mounting fixture to rotate upward as shown by arrow 1108. The mounting fixture is gradually rotated upward exposing and moving the meat-to-bone interface upward and thereby facilitating removal of the meat from the bone. The mounting fixture is rotated approximately 90° upward thereby allowing the array of chisel blades to completely remove the meat from the entire length of the neck bone structure. However, the rotation upward may vary depending on the meat product. The neck de-boning assembly does not move vertically, thus removal of the meat from the entire length of the neck bone structure is affected by the rotation of the mounting fixture in an upward manner. However, the array of chisel blades sweep about the mounting fixture in an arcual fashion while the chisel blades are extending and retracting in a reciprocating fashion while the entire array is sweeping side-to-side in an arcual fashion. This arcual sweeping pattern is affective to remove the meat from the bone because of the primarily round contour of the neck bone structure. An array of chisel blades is utilized because of the nonuniformity and inconsistency of the overall neck bone structure. The grouping of a subset of the array in closer proximity to one and other; and the angle of extension also facilitate the separation of meat from the bone structure.

Referring to FIG. 12, a perspective view of the neck de-boning chisel blade assembly 1004 attached to the downward extending bracket 1006 is shown. The neck de-boning chisel blade assembly includes a chisel blade head assembly 1201 which is attached to a head assembly bracket 1212 which is further adjustably mounted to angle adjustment bracket 1214. The angle of extension of the chisel blade can be adjusted by adjusting the angular relationship between brackets 1212 and 1214 by using angular adjustment member 1216. Brackets 1212 and 1214, having the chisel blade head assembly 1201 attached thereto, are reciprocatingly attached to an engaging/disengaging actuator assembly 1218 by actuator rod members 1220. The actuator 1218 is adapted to controllably retract the chisel blade head assembly and brackets 1212 and 1214 attached thereto to a disengaged position and extend the chisel blade head assembly to an engaged position utilizing the actuator rods 1220. The direction of the extension and retraction of the chisel blade head assembly is indicated by arrow 1222.

The chisel blade assembly 1004 is mounted to the downward extending bracket 1006 which is attached to the rotation plate 1008 as shown in FIG. 10. As discussed previously, the chisel blade assemblies 1004 are mounted to the rotation plate by downward extending brackets 1006 in an arcual pattern about the mounting fixture. It was further noted above that the rotation plate is adapted to rotate or sweep side-to-side and thereby causing the array of chisel blades to rotate or sweep side-to-side in an arcual fashion about the mounting fixture. This arcual sweeping direction of the chisel blade assemblies is indicated by arrow 1224. Also, as indicated previously, as the chisel blade assemblies are sweeping side-to-side in an arcual pattern, the chisel blade is iteratively extending and retracting in a reciprocating fashion as indicated by arrow 1226. The chisel blade 1202 extends through slide bearing 1204 and further extends to removably attach to joint member 1206 which is further attached to an actuator rod which extends from chisel drive actuator 1208. The actuator rod is not shown in this view because the chisel blade is in its retracted position. Also shown, is a proximity sensor 1210 which is communicably linked to a controller. The proximity sensor 1210 is designed to sense the position of the actuator rod and is further adapted to provide the position information to a controller which utilizes the information to determine if the chisel blade is reciprocating properly. For example, the controller could determine if the chisel blade is bound such that reciprocation has halted because the position of the actuator rod remains constant when reciprocation should be occurring. The controller which is communicably linked to the chisel drive actuator and the engaging/disengaging actuator can respond to this condition by controlling the chisel drive actuator to fully retract the chisel blade and control the engaging/disengaging actuator to retract the entire chisel blade head assembly. This movement should free up the chisel blade at which time operation can continue. The chisel blade head assembly 1201 is mounted to head assembly bracket 1212 with a lateral degree of compliancy in the direction indicated by arrow 1228. This lateral degree of compliancy should assist the chisel blade in maneuvering around the various contours of the bone structure, as well as preventing the chisel blade from becoming bound. A proximity sensor 1106 can be utilized to sense the degree of angular offset of the chisel blade head assembly.

Referring to FIG. 12A, a side view of the chisel blade assembly 1004 and the downward extending mounting bracket 1006 is shown. The side view reveals a different view of the ends of the spring member 1102 and retention member 1104 which provides for the degree of lateral compliancy. Pivotal mount 1230 attaches the chisel head assembly 1201 to the head assembly mounting bracket. The chisel head assembly 1201 pivots laterally about this pivot mount 1230. Proximity sensor 1106 is designed to sense the lateral angular offset of the chisel blade head assembly from its center nominal position as it compliantly pivots about pivot mount 1230. The proximity sensor 1106 which is communicably linked to a controller, can provide the angular offset information to the controller such that the controller can determine if the chisel blade has compliantly pivoted to an offset angle greater than desired, and further the position is fixed and does not correct to its center position. The controller can utilize this information to determine if the chisel blade is bound such that it is not moving. If this occurs, the controller, which is communicably linked to the chisel drive actuator and the engage/disengage actuator, can control the chisel drive actuator to retract fully the chisel blade and can further control the engage/disengage actuator to fully retract the chisel blade head assembly such that the chisel blade is freed.

Referring back to FIG. 12, please note that the side edges 1240 of the chisel blade, are sharpened and the chisel blade end 1242 is unsharpened. The unsharpened chisel blade end is provided such that the chisel blade does not chip away or cut away the bone structure during the de-boning process. The edges 1240 are sharpened such that as the chisel blade is reciprocating and sweeping side-to-side in an arcual fashion, the meat is severed from the bone structure.

The one embodiment of the invention for removing bones from a sub-primal cut meat portion as described above is designed to remove the rib bone structure and the neck bone structure from the sub-primal cut of meat referred to as the chuck blade. The one embodiment of the apparatus as described above is adapted to execute a process for removing the rib bone and the neck bone structures from the chuck blade sub-primal cut. The process begins during the load operation where the sub-primal cut of meat, particularly the chuck blade for this embodiment, is taken by the operator, who is positioned at the loading station, and mounted. However, prior to mounting, the operator removes any skeletal structure remnant from the mounting fixture that has been previously separated. The operator then loads a chuck blade on the mounting fixture by hanging the meat cut on the dagger pin or hook protruding from the mounting fixture. This is accomplished by inserting the dagger pin through an opening of the channel through one of the thoracic vertebrae, preferably the third through the fifth vertebrae. A clamp is then engaged to affix the sub-primal cut of meat or chuck blade more securely on the mounting fixture. This mounting fixture provides the ability to hold and position the meat cut for the de-boning process, which previously was manually intensive. When all stations indicate ready, the rotation table rotates the mounting fixture having the sub-primal meat cut mounted thereon to a position adjacent the rib de-boning station. The rotation table performs this rotation when all blade stations have completed their latest cutting operation and has provided a control signal indicating that they are ready for the next rotation. The rib de-boning station performs its operation. When all stations indicate ready, the meat cut that has been just processed at the rib de-boning station can be transitioned to the position adjacent the neck de-coning station by rotating the rotation table. The neck de-boning station then performs its operation. The chisel blade autonomously separates the meat from the bone, which was previously performed by utilizing a flexible handheld knife and was a manually intensive operation. The neck de-boning assembly pivots upwards to its disengage position. When all stations are indicating ready, the carousel assembly will then rotate the mounting fixture having the bone structure thereon and will rotate the mounting fixture to a dismount station where the remaining bone structure can be removed from the mounting fixture. The cycle is repeated as necessary.

The entire chuck blade de-boning machine can be automatically or semi-automatically controlled by a controller system. The controller system can be a computer based or PLC based control system. The control system is adapted to be programmable such that each process step performed by the de-boning machine can be controlled in software. The control system is communicably linked to all actuators described herein, including the chisel drive actuators and all power sources and drive mechanisms.

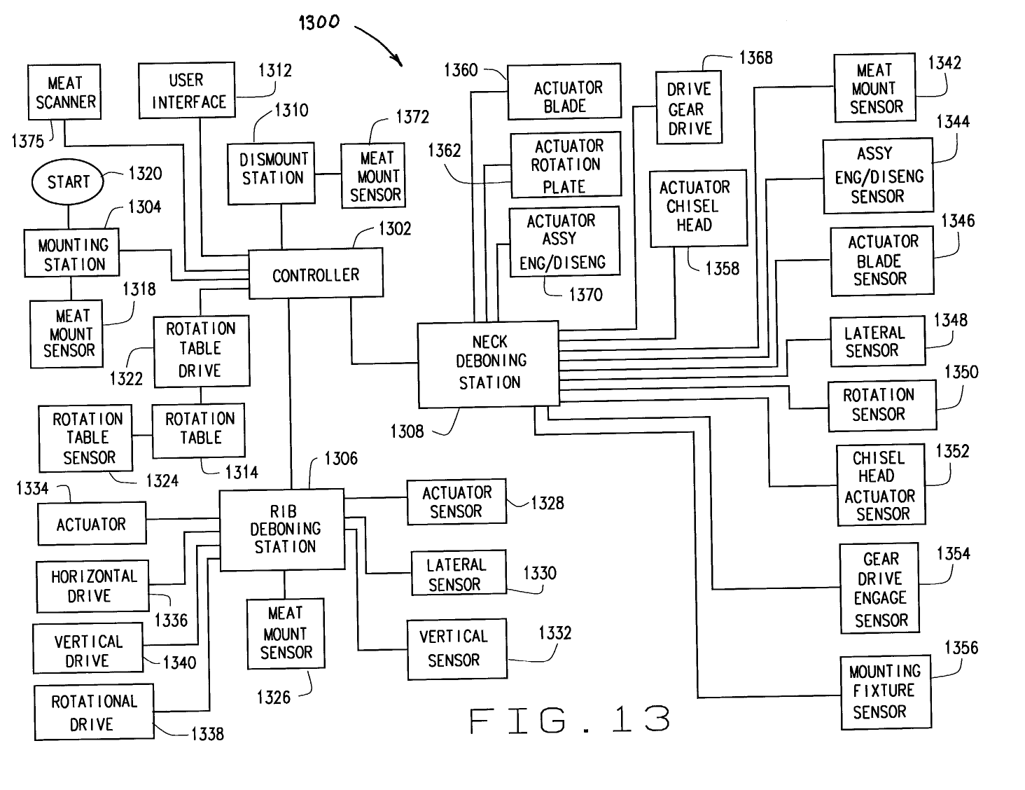

Referring to FIG. 13, a system diagram is shown for one embodiment of the chuck blade de-boning system 1300. The chuck blade de-boning system includes a controller 1302 which is communicably linked to four operation stations, including a mounting station 1304, a rib de-boning station 1306, a neck de-boning station 1308 and a dismount station 1310. The controller 1302 is further adapted to be communicably linked to a user interface 1312 such as a keyboard and monitor or a complete personal computer or other computing means. The controller can further be linked to the rotation table 1314. Also, the controller 1302 can optionally be communicably linked to a meat scanning system 1375 which is adapted to obtain a three-dimensional scan image of the bone structure of the meat cut. This will allow for a specialized custom program to be developed that controls the meat removal process from a specific bone structure that is based on specific dimensions of the bone structure as it was scanned. This dynamic program designed to specifically address a specific bone structure will increase the yield considerably. The meat scanning function could be provided by any appropriate means such as three-dimensional x-ray technology or three-dimensional ultrasound technology. Any such meat-scanning interface must be communicably linked to the controller.

Each of the stations have sensor devices, actuators, and/or drive means communicably linked therethrough to the controller and each station is adapted to provide a station-ready signal to the controller when the station has completed its operation on a given meat cut. The sensors can be mechanical electromechanical, electrical, eledro-optical, or other appropriate sensors for the specific application.

The mounting station can be adapted with a meat mount sensor 1318 that senses when a meat cut has been mounted on the mounting fixture and appropriately clamped in place so that the mounting station can provide a mounting station ready signal. The mounting station can also be equipped with an activation means such as a start button 1320 that can pressed by an operator which provides a mounting station ready indication to the controller. The controller 1302 is also communicably linked to the rotation table 1314 through which the controller is communicably linked to the rotation table drive 1322 such that the controller can control the rotation table drive to rotationally transition a mounting fixture to the next station. The rotation table 1314 is equipped with a rotation table sensor 1324 which can sense when a mounting fixture has been transitioned to a position adjacent a station. The controller will initiate this rotational transition when all stations indicate ready and the controller has received indications that there is still meat cuts to be processed.

The controller 1302 is also communicably linked to the rib de-boning station 1306 which is further linked therethrough to a meat cut present sensor 1326, a chisel blade actuator sensor 1328, a lateral compliance sensor 1330, a vertical compliance sensor 1332, a blade actuator 1334, a horizontal roller plate drive 1336, a rotational drive 1338 and a vertical roller plate drive 1340. Also, the rib de-boning station is adapted to provide a station-ready signal to the controller when it has completed the process being performed on the current meat cut and the station is ready to receive a new meat cut for processing at the rib de-boning station. The meat cut present sensor 1326 can provide a signal to the controller notifying the controller that a meat cut is mounted on the mounting fixture adjacent the rib de-boning station. The chisel blade actuator sensor 1328 is adapted to sense the degree of extension of the chisel blade and provides the positional information to the controller such that the controller can determine if the chisel blade is reciprocating properly or is bound in a fixed position. If the actuator sensor indicates that the chisel blade is in a fixed position, then the controller can interpret the signal being provided by the actuator sensor to conclude that the chisel blade is bound. The controller can then take the necessary measures to unbind the chisel blade by controlling blade actuator 1334 to fully retract chisel blade and controlling the horizontal roller plate drive 1336 to retract the entire chisel blade assembly.

The lateral compliance sensor 1330 and the vertical compliance sensor 1332 perform a similar function, however, they provide information with regard to the degree of rotation of the chisel blade along the direction of compliance. When the chisel blade encounters an obstruction, the chisel blade will rotate along the direction of compliance and this rotation can be sensed by the sensor by sensing an angular offset along the direction of compliance. If the sensor provides an indication that the offset has become static, then the controller can interpret this information to indicate that the chisel blade is bound. Therefore, the controller can take the appropriate measures to unbind the chisel blade. The horizontal track plate drive and the rotational drive and the vertical track plate drive are all communicably linked through the rib de-boning station to the controller, and the controller is adapted to control these drives to spatially position the chisel blade assembly.

The controller can be programmed to affect a sequence of chisel blade assembly maneuvers and cutting actions to optimally separate the meat from the bone structure. As indicated previously, the preferable starting position for the rib de-boning process for the chuck blade is positioning the end of the chisel blade at the base of the fifth feather bone at the fifth feather bone and fifth rib joint. The controller is further adapted to control the blade actuator to initiate actuation of the blade creating a reciprocating action that severs the meat from the bone as the reciprocating blade travels side-to-side in an arcual fashion. In addition to the reciprocating action of the chisel blade, the different drive means are controlled by the controller to affect a side-to-side arcual sweeping motion of the chisel blade which is further affected by controlling the rotational drive and the horizontal track plate drive. In addition to actuating the chisel blade and performing a side-to-side sweeping action, the controller also controls the vertical track plate drive to affect vertical movement of the chisel blade assembly thereby allowing the chisel blade assembly to transition down the entire length of the rib bone structure. Please note that other functions can be added to the rib de-boning station such as a vision system adapted to further dynamically guide the chisel blade assembly without departing from the scope of this invention.

A neck de-boning station 1308 is also communicably linked to controller 1302. There is also a plurality of sensor devices communicably linked through the neck de-boning station to the controller 1302. For example, a meat cut present sensor 1342 adapted to sense when a meat cut is mounted on the mounting fixture adjacent the neck de-boning station can provide a meat cut present signal to the controller. There can also be a neck de-boning assembly disengage/engage sensor 1344 that senses whether the neck de-boning assembly has been retracted to the disengage position or whether it is lowered to the engage position. This information can be provided to the controller for subsequent use in controlling the engage/disengage neck bone assembly actuator. The chisel blade actuator sensor 1346 is adapted to sense the degree of extension of the chisel blade and the positional information can be provided to the controller. There can be a chisel blade actuator sensor for each of the five chisel blade assemblies in the array of chisel blade assemblies. The chisel blade actuator sensor identifies whether the chisel blade has become fixed at a specific degree of extension and the controller can interpret this information to indicate that the chisel blade is bound and that the controller can take the appropriate action to unbind the chisel blade. The lateral compliance sensor 1348 can sense the lateral degree of angular offset from nominal along the direction of compliance. The lateral compliance sensor will output information that can be interpreted by the controller to determine if the chisel blade has become fixed at a particular degree of offset from nominal along the direction of compliance thereby indicating that the chisel blade has become bound. Therefore, the controller can take the appropriate measures to unbind the chisel blade, by controlling the blade actuator 1360 to fully retract the blade and controlling the engage/disengage actuator 1358 to retract the chisel blade head assembly.

The rotation plate sensor 1350 is adapted to sense the rotational angular offset of the rotation plate with respect to its nominal center position. As the rotation plate rotates, the rotation plate sensor senses the degree of extension of the array rotation actuators 1010 and 1012 as shown in FIG. 10. The sensor can provide the information to the controller which can then determine the angular offset of the rotation plate with respect to its nominal center position. This information can be utilized by the controller to determine if the entire array has become bound or some other failure has occurred. The controller can then take corrective measures to fully retract all chisel blades and fully retract all chisel blade head assemblies. The engage/disengage actuator sensor 1352 senses the degree of extension of the chisel blade assembly from the engage/disengage actuator. This information can be provided to the controller 1302. This information can be utilized by the controller to determine if the individual chisel blade is engaged and performing the cutting process or whether or not the chisel blade is disengaged and temporarily inactive. For example, if one or more chisel blade head assemblies are retracted multiple times during a single rotational pass of the array, the controller may determine that the pass must be performed again prior to proceeding with the cutting process. The drive gear engage sensor 1354 is adapted to sense when the drive gear has engaged the mounting fixture gear such that the drive gear can begin to affect rotation of the mounting fixture. The mounting fixture rotation sensor 1356 is adapted to sense when the mounting fixture has been fully rotated upward which is indicative of the neck de-boning process being complete. This information can be provided to the controller which allows the controller to determine when the neck de-boning process has been completed and when to halt the cutting operation.

The controller 1302 is also communicably linked to the disengage/engage actuators 1358, the blade actuators 1360, the rotation plate actuators 1362, the drive gear drive 1368 and the neck de-boning assembly engage/disengage actuator 1370. The controller 1302 controls these drives and actuators via these communication links to affect movement of the various components of the system. For example, the controller is adapted to control the blade actuators to affect the reciprocating action of the chisel blade. The controller affects the side-to-side arcual sweeping pattern of the array by controlling the rotation plate actuators. Further, the controller controls the drive gear drive 1368 to affect the upward rotation of the mounting fixture such that the meat can be separated from the entire length of the neck bone structure.

The controller can also be communicably linked to a dismount station 1310 having a meat mount sensor 1372 communicably linked to the controller. The meat mount sensor 1372 can sense when a meat and bone remnant remains mounted on the mounting fixture when it is transitioned from the neck de-boning station to the dismount station. The controller can use this information to notify the operator that a meat and bone remnant requires removal.

The controller 1302 can also be adapted to interface with a user interface such as a remote terminal or a remote computer. The user interface can be adapted to provide commands to the controller to affect certain maneuvers and functions of the system. The user interface can also be utilized to reprogram the controller with a new set of operating instructions.

As discussed above, the bone structure anatomy of a meat cut can be examined to determine the general geometry, contours and shapes and the like, in order to categorize various bone structures. By categorizing a bone structure, one can more efficiently and optimally choose a de-boning means for separating a given category of bone structure from the meat of a meat cut. As noted above, the bone structure of the chuck blade sub-primal meat cut was divided into two categories of bone structure, the thoracic vertebrae and the cervical vertebrae. One method of determining the bone structure anatomy as discussed above, can be the utilization of a meat scanner 1375 which is an apparatus that is adapted to examine the anatomy of a bone structure and capture electronic imaging information that is representative of the geometry and contours of the bone structure anatomy. Also, as mentioned above, this meat scanner system can be an x-ray imaging based system, a sonar imaging based system or any other appropriate imaging system that can capture multi-dimensional or specifically three-dimensional imaging information of the bone structure anatomy. This imaging information can be captured and stored electronically such that it can be utilized to determine the de-boning means or cutting implement utilized for the de-boning process. Also, the cutting pattern and maneuvers can be determined based on this imaging information. As discussed above, the imaging information can be utilized to select a sequence of cutting patterns and maneuvers from a preprogrammed set of cutting patterns and maneuvers that can be performed by the cutting implement or de-boning means. With regard to the specific embodiments described herein, the reciprocating chisel blade de-boning assembly can be controlled to perform a preprogrammed set of maneuvers. The meat scanner 1375 can be adapted to be communicably linked to the controller 1302 which can be adapted to select a sequence of cutting patterns and maneuvers based on the imaging information captured and stored electronically from the meat scanner 1375.

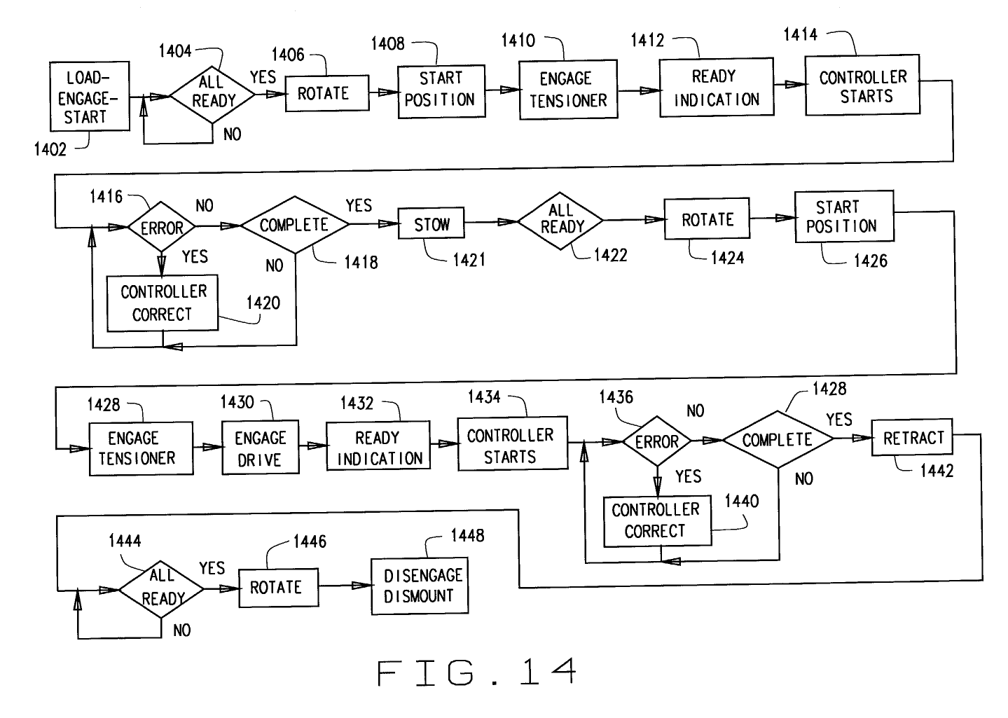

Referring to FIG. 14, a flow diagram of one system embodiment is shown. The process is started by loading the product, engaging the clamp and providing a start indication as indicated by functional block 1402. The next step in the flow is determining if all stations are ready as indicated by decision block 1404. If there is not an all stations ready indication, the system will continue to check until an all stations ready indication is provided. If an all stations ready indication is provided, the next process step would be to rotate the rotation table to position the meat product adjacent the first de-boning station as indicated by functional block 1406. Once the product has been positioned adjacent the de-boning assembly, the de-boning assembly is positioned in a start position as indicated by functional block 1408. The next process step is to engage the tensioner assembly to provide additional tension at the meat de-bone interface as indicated by functional block 1410. A ready indication is then provided once the de-boning assembly has been positioned in a start position and the tensioner assembly has been engaged as indicated by functional block 1412. The controller will then control the de-boning assembly to commence the de-boning process as indicated by functional block 1414. The controller will continue the de-boning process until the de-boning process is completed as indicated by decision block 1418. Also, during the de-boning process, error indications are continuously monitored to determine if the controller needs to take corrective measures as indicated by decision block 1416 and functional block 1420. For example, if the de-boning assembly provides an indication to the controller that it is bound, then the controller will take corrective measures to unbind the de-boning assembly. Once the first de-boning process is completed, the de-boning assembly is retracted to its stowed position as indicated by functional block 1420. The system will then monitor to determine if all stations are ready as indicated by decision block 1422. If all stations do not indicate ready, the system will continue to monitor until all stations indicate ready. When all stations indicate ready, the next step is to rotate the product to the next de-boning station is indicated by functional block 1424. The controller then controls the next de-boning assembly to maneuver to the start position as indicated by functional block 1426. The controller will then control the tensioner assembly to apply tension to the product in order to provide additional tension at the meat de-bone interface as indicated by functional block 1428. The controller will then control the drive gear drive to raise to an engage position with the mounting fixture gear as indicated by functional block 1430. A ready indication is then provided as indicated by functional block 1432. The controller will then control the de-boning assembly to commence the de-boning process which includes controlling the drive gear drive to rotate the mounting fixture upward toward the de-boning assembly as indicated by functional block 1434. The de-boning process will continue until it is completed as indicated by decision block 1438. During the de-boning process, the controller will continue to monitor for error indications and will take corrective measures as required as indicated by decision block 1436 and functional block 1440. Once the de-boning process is completed, the de-boning assembly is retracted to its stowed position as indicated by functional block 1442. The controller will then check to see if all stations indicate ready as indicated by decision block 1444. If all stations do not indicate ready, the controller will continue to monitor for an all stations ready indication. When all stations indicate ready, the controller will control the rotation table drive to rotate the rotation table to position the product remnant at the dismount station as indicated by functional block 1446. The product remnant is then unclamped and dismounted as indicated by functional block 1448. The process steps are repeated as necessary.

Both the neck de-boning chisel blade assembly and the rib de-boning chisel blade assembly can be controlled by a PLC or some other comparable computing device. The PLC controls the specific maneuvers and cutting patterns of the reciprocating chisel blade assemblies. The maneuvers and cutting patterns can be preprogrammed into the PLC through a user interface such that the de-boning procedure can be fully autonomous or semi-autonomous. The maneuvers and/or cutting patterns that the chisel blade must perform in order to effectively remove bones from the sub-primal cut can be determined through various methods. One method can be to allow an operator to manually control every range of motion of the chisel blade assembly and any attached or associated parts in order to perform the process steps and maneuvers for removing the bones from the sub-primal cut. Once the operator has performed this task on multiple sub-primal cuts of the same type, a pattern can be determined that can be utilized to preprogram into the PLC a preset sequence of maneuvers and cutting patterns. Another method would be to model the skeletal bone structure of the sub-primal cut and utilize other known parameters such as texture and tensil strength of meat in order to develop an effective set of maneuvers and cutting patterns to remove the meat from the sub-primal cut. Another method would be to store preset maneuvers or cutting patterns that the chisel blade assembly is capable of performing where those electronically stored maneuvers and cutting patterns can be electronically selected and executed in any desired sequence. Therefore, as an option the de-boning system could dynamically sense the geometry and capture and store in an electronic storage means the imaging information of the skeletal bone structure for each sub-primal meat cut by utilizing a three-dimensional x-ray based or sonar based or other appropriate imaging device, scan an image of the bone structure and then selecting a sequence of maneuvers and cutting patterns from the pre-programmed set that will effectively sever the meat from the bone. With any of the above options, the system can be adapted to simultaneously operate all stations.

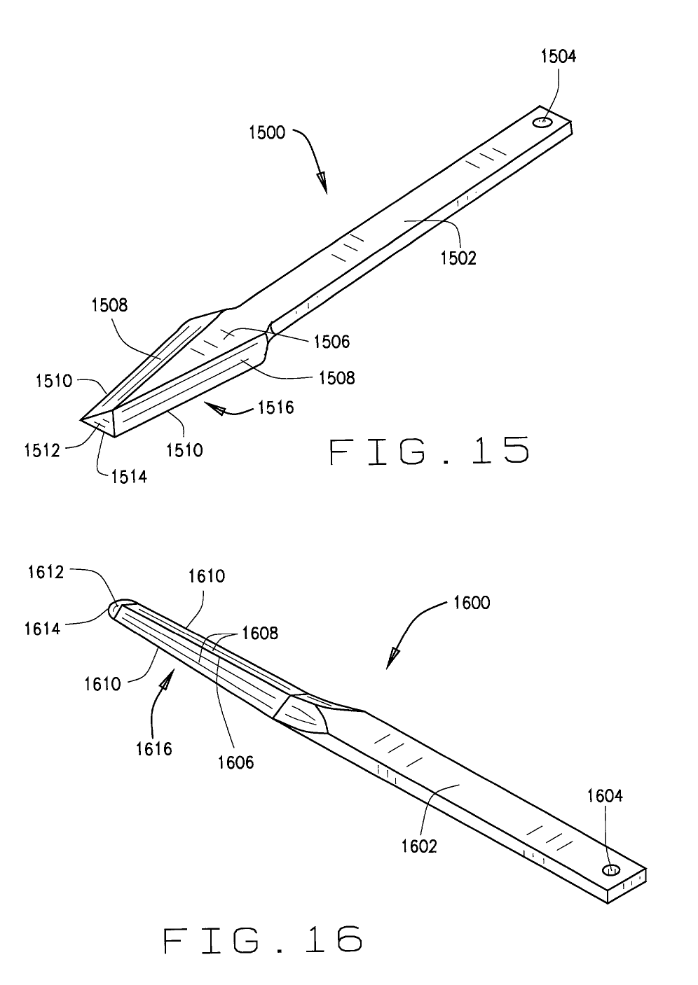

Referring to FIG. 15, one embodiment of a rib bone chisel blade 1500 is shown. This embodiment of a rib bone chisel blade comprises an elongated chisel blade handle 1502 which further comprises an attachment end 1504 which is adapted to removably attach to an actuation device and has a chisel blade head 1506 attached to and extending from the opposing end. The chisel blade head is substantially flattened and has beveled sides 1508 and a beveled end 1512. The side edges 1510 are inwardly tapered as they narrow toward the end 1512. The side edges 1510 are also substantially sharpened, whereas, the tip end 1514 is substantially unsharpened. The underside 1516 of the chisel blade head 1506, which cannot be seen from this view, is substantially identical to the top view as shown. The bevels, tapers and sharpened edges can be varied to accommodate the specific bone structure.

Referring to FIG. 16, a neck de-boning chisel blade 1600 is shown which comprises an elongated chisel blade handle 1602 having an attachment end 1604 and a chisel blade head 1606 attached to and extending from the opposing end of handle. The attachment end 1604 is adapted to be removably attached to an actuation device. The chisel blade head 1606 has beveled sides 1608 and a rounded beveled end 1612. The side edges 1610 are inwardly tapered to narrow toward the blade end 1612 and the side edges are sharpened. The tip end 1614 is substantially unsharpened. The underside of the chisel blade head is substantially flat. The bevels, tapers and sharpened edges can be varied depending on the bone structure.

The various de-boning assembly examples shown above illustrate a novel de-boning apparatus and method. A user of the present invention may choose any of the above de-boning apparatus or method embodiments, or an equivalent thereof, depending upon the desired application. In this regard, it is recognized that various forms of the subject de-boning invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. An apparatus for separating meat from bone for a cut of meat comprising:
a chisel blade having a chisel head end extending from a first end of said chisel blade and said head having at least one substantially sharpened edge and an actuator operatively attached to said chisel blade on an opposing second end of said chisel blade and said actuator adapted to reciprocatingly extend and retract the chisel blade; and
said chisel blade and said actuator mounted on a chisel blade head assembly bracket having at least one spring member attached to said bracket and adapted to provide for built-in compliance in at least one direction of compliance.

2. The apparatus for separating meat from bone as recited in claim 1 further comprising:
a proximity sensor operatively attached to said chisel blade head assembly bracket such that said proximity sensor senses the degree of movement of said chisel blade head assembly bracket along the at least one direction of compliance.

3. The apparatus for separating meat from bone as recited in claim 2 further comprising:
a controller communicably linked to said actuator and said proximity sensor and said controller adapted to automatically control said actuator to affect reciprocation of said chisel blade and said controller further adapted to receive information provided by said proximity sensor and further automatically control said actuator responsive to said proximity sensor information.

4. The apparatus for separating meat from bone as recited in claim 3 further comprising:
a positioning arm operably attached to said at least one spring member, said positioning arm having at least one power source adapted to affect movement of the position arm in at least one direction for maneuvering of the chisel blade, said power source communicably linked to the controller, and said controller operable to control the power source to affect maneuvering of the chisel blade.

5. The apparatus for separating meat from bone as recited in claim 4 further comprising:
a meat scanner adapted to examine the bone structure anatomy of a meat cut and capture multi-dimensional imaging information of the bone structure and said meat scanner is communicably linked to said controller; and
said controller operable to capture and electronically store the imaging information, and said controller further operable to control the power source and the actuator to affect maneuvering and actuation of the chisel blade based on the imaging information.

6. An apparatus for separating meat from bone for a cut of meat comprising:
a meat de-boning system having a main platform and a center support structure extending upward from said main platform;
at least one de-boning station platform attached to and extending radially out from said center support structure;
a rotation table rotatably attached to said main platform and said rotation table adapted to affect rotation about the center support structure;
at least one mounting fixture attached to the outermost perimeter edge of said rotation table where rotation of said rotation table positions the at least one mounting fixture adjacent a de-boning station platform;
at least one reciprocating de-boning chisel blade assembly attached to at least one de-boning station platform; and
said at least one de-boning chisel blade assembly including a chisel blade and an actuator operatively attached to said chisel blade and said actuator adapted to affect reciprocation of said chisel blade.

7. The apparatus for separating meat from bone as recited in claim 6 further comprising:
a controller communicably linked to said rotation table and to said actuator and said controller adapted to automatically control said rotation table to affect rotation of said table for positioning the mounting fixture adjacent the de-boning station platform and further adapted to automatically control said actuator to affect reciprocation of said chisel blade.

8. A de-boning system for meat cuts comprising:
a de-boning system main platform;
at least one de-boning station attached to said platform and at least one reciprocating chisel blade assembly attached to at least one de-boning station, and said chisel blade assembly including a chisel blade and an actuator operatively attached to said chisel blade and said actuator adapted to affect reciprocation of said chisel blade; and
a conveyor adjacent said platform and said conveyor having a meat mounting fixture attached thereto and said conveyor adapted to convey said mounting fixture and any meat mounted thereon to a position adjacent said de-boning station.

9. The de-boning system for meat cuts as recited in claim 8 further comprising:
a tensioner assembly mounted to said main platform having a tensioning arm including a tensioner hook operably attached to said arm and said tensioner assembly adapted to controllably apply a pulling tension to the meat cut utilizing the tensioner hook for facilitating separation of meat from bone.

10. A de-boning system for meat cuts as recited in claim 8 further comprising:
a controller communicably linked to said conveyor and to said actuator and said controller adapted to automatically control said conveyor to affect conveyance of said conveyor for positioning the mounting fixture adjacent the de-boning station platform and further adapted to automatically control said actuator to affect reciprocation of said chisel blade for de-boning the meat cut.

11. A conveyor and mounting fixture for mounting, holding and manipulating a meat cut during de-boning by a chisel blade assembly comprising:
a conveyor adapted to convey adjacent a de-boning station platform said conveyor having a mounting panel rotatably attached to said conveyor by an axle bearing assembly and said conveyor adapted to convey said mounting panel to a position adjacent said de-boning station platform;
said mounting panel having a flat straight portion and an arched portion;
a hooking member extending from the flat straight portion for hooking and hanging a meat cut; and
said axle bearing assembly adapted to be operatively connected to a drive source adapted for affecting rotation of the mounting panel about the axle bearing assembly in a substantially tangential relationship with the reciprocating chisel blade de-boning assembly to facilitate de-boning of the meat cut.

12. The conveyor and mounting fixture as recited in claim 11 further comprising:
a clamp operatively attached to said mounting panel and said clamp adapted to clamp a portion of a bone structure of said meat cut to said mounting panel; and
a controller communicably linked to said actuator, to said conveyor and to said drive source and said controller adapted to automatically control said actuator to affect reciprocation of said chisel blade and said controller adapted to automatically control said conveyor for positioning the mounting panel and said controller is further adapted to automatically control said drive source to affect rotation of said mounting panel in a substantially tangential relationship with the de-boning assembly.

13. The conveyor and mounting fixture as recited in claim 11 where said de-boning station platform has a reciprocating chisel blade de-boning assembly attached and said chisel blade de-boning assembly including a chisel blade and an actuator attached to said chisel blade and said actuator adapted to affect reciprocation.

14. A de-boning apparatus for separating meat from a bone structure of a meat cut comprising:
a vertical track panel;
a vertical roller plate slidably attached to said vertical track panel and said vertical roller plate having a vertical track power source adapted to affect vertical up and down movement of said vertical roller plate along the vertical track panel;
a pivoting assembly attached to said vertical roller plate and a positioning arm attached to said pivoting assembly and said positioning arm horizontally extending radially therefrom and said pivoting assembly having a pivot power source adapted to affect rotation of said positioning arm about said pivoting assembly;
a horizontal track panel attached to said positioning arm;
a horizontal roller plate slidably attached to said horizontal track panel and said horizontal roller plate having a horizontal track power source adapted to affect horizontal radial displacement of said horizontal track panel along the horizontal track panel; and
a reciprocating chisel blade assembly attached to said horizontal roller plate, said reciprocating chisel blade assembly including a chisel blade and an actuator attached to said chisel blade and said actuator adapted to affect reciprocation of the chisel blade.

15. The de-boning apparatus for separating meat as recited in claim 14 further comprising:
a controller communicably linked to the vertical track power source, the pivot power source, the horizontal track power source and the actuator and said controller adapted to automatically control the vertical track power source, the pivot power source, the horizontal track power source, and the actuator to affect automatic movement of the de-boning apparatus for de-boning a meat cut.

16. A de-boning apparatus for separating meat from a bone structure of a meat cut comprising:
a rotational plate having a power source adapted to affect rotation of the rotational plate about a center pivot;
at least one support member extending downward from the rotational plate and adjustably attached by one end to said rotational plate;
at least one reciprocating chisel blade assembly attached to at least one of the support members;
said chisel blade assembly further comprising a chisel blade and a chisel blade actuator and said actuator operatively attached to said chisel blade and said actuator adapted to affect reciprocation of said chisel blade for separating meat from bone.

17. The de-boning apparatus for separating meat as recited in claim 16 where said rotational plate further comprises a retraction actuator adapted to upwardly retract and downwardly engage the rotational plate about a retraction center pivot.

18. The de-boning apparatus for separating meat as recited in claim 17:
a controller communicably linked to the power source, the actuator, and the retraction actuator and said controller adapted to automatically control said power source to affect rotation of said rotation plate, said retraction actuator to affect retraction and engagement and said controller further adapted to automatically control said actuator to affect reciprocation of said chisel blade.

19. A de-boning apparatus for separating meat from bone for a cut of meat comprising:
a chisel blade having a chisel head end extending from a first end of said chisel blade and said head having substantially sharpened side edges and a first actuator operatively attached to said chisel blade on an opposing second end of said chisel blade and said first actuator adapted to reciprocatingly extend and retract the chisel blade;
said chisel blade and said first actuator mounted on a chisel blade head assembly bracket having at least one spring member attached to said bracket for built-in compliance in at least one direction; and
a second actuator operatively attached to said chisel blade head assembly bracket by said at least one spring member and said second actuator adapted to reciprocatingly extend and retract the chisel blade head assembly bracket.

20. The de-boning apparatus for separating meat from bone as recited in claim 19 further comprising:
a proximity sensor operatively attached to said chisel blade head assembly bracket such that said proximity sensor senses the degree of displacement of said chisel blade head assembly bracket along the direction of compliance;
a first displacement proximity sensor operatively attached to said first actuator such that said first displacement proximity sensor senses the degree of extension of the chisel blade along the direction of reciprocation;
a second displacement proximity sensor operatively attached to said second actuator such that said second displacement proximity sensor senses the degree of extension of the chisel blade head assembly bracket along the direction of reciprocation.

21. The de-boning apparatus for separating meat from bone as recited in claim 20 further comprising:
a controller communicably linked to said first actuator, to said second actuator, to said proximity sensor, to said first displacement proximity sensor and to said second displacement proximity sensor and said controller adapted to automatically control first and second actuators to affect reciprocation of the chisel blade and the chisel blade head assembly bracket and said controller further adapted to receive information from said proximity sensor, from said first displacement proximity sensor and said second displacement proximity sensor and further adapted to control first and second actuators responsive to said information.

22. A de-boning system for meat cuts comprising:
a main platform;
a rotation table operatively attached to said main platform;
a center support structure extending up from said main platform above said rotation table;
at least one de-boning station platform extending radially out from said center support structure above said rotation table;
a mounting fixture mounted at the outer perimeter of said rotation table;
at least one reciprocating chisel blade assembly mounted to at least one de-boning station platform and said at least one chisel blade assembly including a chisel blade and actuator attached thereto, said actuator adapted to affect reciprocation of said chisel blade; and
said rotation table adapted to rotate the mounting fixture to a position adjacent at least one reciprocating chisel blade assembly.

23. A method for separating meat from a neck bone structure of a chuck blade sub-primal cut comprising the steps of:
supporting the neck bone structure on an arched surface adapted for arching outward each cervical vertebra and separating each cervical vertebra away from each other;
plunging into and retracting from a meat and bone interface repetitively with a reciprocating action with at least one reciprocating chisel blade;
moving the chisel blade with an arcual motion about the neck bone structure while continuing reciprocation until the meat and bone interface is severed; and
transitioning the chisel blade the full length of the neck bone structure iteratively repeating the reciprocating action and arcual movement of the chisel blade until a desired portion of meat is severed from the neck bone structure.

24. The method of separating meat from a neck bone structure as recited in claim 23 where the reciprocating chisel blade includes an actuator adapted to affect the reciprocating action of the chisel blade and said actuator communicably linked to a controller where said controller is adapted to automatically control said actuator to control reciprocating action of the chisel blade.

25. The method of separation meat from a neck bone as recited in claim 24 further comprising the steps of:
sensing the position and orientation of the chisel blade with one or more proximity sensors;
communicating the position and orientation of the chisel blade to the controller;
determining if the chisel blade is fixed in an undesired position or orientation with the controller; and
controlling the actuator to control the chisel blade to retract fully away from said neck bone structure if the chisel blade is fixed in an undesired position or orientation.

26. A method for separating meat from a neck bone structure of a chuck blade sub-primal cut comprising the steps of:
supporting the neck bone structure on an arched surface adapted for arching outward each cervical vertebra and separating each cervical vertebra away from each other;
plunging and retracting repetitively with a reciprocating action into a meat and bone interface with at least one reciprocating chisel blade;
moving the chisel blade with an arcual motion about the neck bone structure while continuing reciprocation until the meat and bone interface is severed; and
rotating arched surface with the neck bone structure supported thereon in a substantially tangential relationship with at least one reciprocating chisel blade until a desired portion of the meat is severed from the bone.

27. The method of separating meat from a neck bone structure as recited in claim 26 where the reciprocating chisel blade includes an actuator adapted to affect the reciprocating action of the chisel blade and said actuator communicably linked to a controller where said controller is adapted to automatically control said actuator to control reciprocating action of the chisel blade.

28. The method of separating meat from a neck bone as recited in claim 27 further comprising the steps of:
sensing the position and orientation of the chisel blade with one or more proximity sensors;
communicating the position and orientation of the chisel blade to the controller;
determining with the controller if the chisel blade is fixed in an undesired position or orientation; and
controlling the actuator to control the chisel blade to retract fully away from said neck bone structure if the chisel blade is fixed in an undesired position or orientation.

29. A method for separating meat from a rib bone structure of a chuck blade sub-primal cut comprising the steps of:
hanging the rib bone structure vertically;
plunging into and retracting from a meat and bone interface repetitively with a reciprocating action with at least one reciprocating chisel blade;
moving the chisel blade with a arcual motion about the rib bone structure while continuing reciprocation until the meat and bone interface is severed; and
transitioning the chisel blade the full length of the rib bone structure repeating the reciprocating action and arcual movement of the chisel blade until a desired portion of meat is severed from the neck bone structure.

30. The method for separating meat from a rib bone structure as recited in claim 29 further comprising the steps of:
hooking a tensioner hook in the chuck blade sub-primal cut; and
applying a pulling tension to the sub-primal cut to facilitate separating meat from bone.

31. A method of separating meat from bone for a meat cut comprising the steps of:
supporting a meat cut on a mounting panel by inserting a hooking member extending from the mounting panel through an opening in a bone structure of the meat cut;
plunging into and retracting from a meat and bone interface repetitively with a reciprocating action with at least one reciprocating chisel blade;
moving the chisel blade with a arcual motion about the rib bone structure while continuing reciprocation until the meat and bone interface is severed; and
transitioning the chisel blade the full length of the rib bone structure repeating the reciprocating action and arcual movement of the chisel blade until a desired portion of meat is severed from the neck bone structure.

32. The method of separating meat from bone for a meat cut as recited in claim 31 where at least one reciprocating chisel blade includes an actuator adapted to affect the reciprocating action of the chisel blade and said actuator communicably linked to a controller where said controller is adapted to automatically control said actuator to control reciprocating action.

33. The method of separating meat from bone for a large meat cut as recited in claim 32 further comprising the steps of:
sensing the position and orientation of at least one chisel blade with at least one proximity sensor;
communicating the position and orientation of at least one chisel blade to the controller;
determining if at least one chisel blade is fixed in an undesired position or orientation with the controller; and
controlling the actuator of at least one chisel blade to control the chisel blade to retract fully away from said meat cut if at least one chisel blade is fixed in an undesired position or orientation.

34. A method of de-boning a meat cut comprising the steps of:
examining the bone structure of a meat cut;
determining at least one category of bone structure having similar structure and contours;
selecting at least one automated de-boning means specifically adapted to de-bone said at least one category of bone structure based upon said similar structure and contours; and
de-boning said at least one category of bone structure with said at least one de-boning means.

35. The method of de-boning a meat cut as recited in claim 34, where the step of examining includes the step of capturing imaging information of the bone structure, and storing said imaging information of the bone structure in an electronic storage means, and where the step of de-boning includes the steps of selecting a sequence of preprogrammed de-boning means maneuvers and cutting patterns from a preprogrammed set where selection of the sequence is based on the imaging information for optimal meat removal, and performing the maneuvers selected.

36. The method of de-boning a meat cut as recited in claim 35 where selecting a least one automated de-boning means is selecting at least one automated chisel blade cutting means having a flattened head with beveled edges and tapers specifically adapted to de-bone said at least one category of bone structure based on similar structures and contours.

37. The method of de-boning as recited in claim 34 where examining the bone structure is performed by a scanning means that captures imaging information and where de-boning said at least one category of bone structure is performed by a reciprocating chisel blade assembly including a chisel blade and an actuator operatively attached thereto and said actuator adapted to affect reciprocation of said chisel blade.
